(19) United States
(12) Patent Application Publication
(10) Pub. No.: US 2014/0286739 A1
(43) Pub. Date: Sep. 25, 2014

(54) BULK MATERIAL UNLOADING AND DISTRIBUTION

(71) Applicant: Partners In Innovation Limited, LLC, Cincinnati, OH (US)

(72) Inventors: John A. Helmsderfer, Cincinnati, OH (US); Andrew Ahr, Cincinnati, OH (US); Mahir Alijagic, Omladinska (BA)

(73) Assignee: Partners In Innovation Limited, LLC, Cincinnati, OH (US)

(21) Appl. No.: 14/297,969

(22) Filed: Jun. 6, 2014

Related U.S. Application Data
(63) Continuation of application No. PCT/US2012/068835, filed on Dec. 10, 2012.
(60) Provisional application No. 61/568,417, filed on Dec. 8, 2011.

(51) Int. Cl. B60P 1/36

(52) U.S. Cl. CPC B60P 1/36
USPC 414/528

(57) ABSTRACT

The disclosure shows an exemplary system for unloading and distributing bulk materials. In one embodiment, a powered conveyor system including a conveyor belt is coupled with the bed of a truck. There may be one or more wings attached to the truck bed for directing the flow of a bulk material from the truck with the conveyor system. Various other embodiments implement different types of vehicles for transporting bulk material.

### CROSS-REFERENCE TO RELATED APPLICATIONS

This application is a continuation application to International PCT Application Serial No. PCT/US2012/68835, entitled “BULK MATERIAL UNLOADING AND DISTRIBUTION”, filed Dec. 10, 2012, which claims priority to U.S. Provisional Patent Application No. 61/568,417, entitled “BULK MATERIAL UNLOADING AND DISTRIBUTION”, filed on Dec. 8, 2011, the disclosure of which is incorporated herein by reference in their entireties.

### TECHNICAL FIELD

The disclosed subject matter generally relates to the field of bulk material handling. More particularly, the subject matter generally relates to the unloading and distribution of bulk materials such as mulch, organic compost, granulated rock salt and other deicers, sand, and gravel.

### BACKGROUND

Commercial and residential landscapes can include numerous planting beds which are often enhanced by the application of ground mulch. New landscape installations or maintenance projects can require the use of topsoil, drainage gravel, decorative stones, compost, mulch, or several of the foregoing, and other like bulk materials. Trends in sustainable and organic plant care include using compost as a substitute for granular and liquefied fertilizers. In areas where the soil is particularly sandy, a thin layer of organic material may be applied over a lawn or landscape area.

The production of mulch involves a grinding process which converts tree limbs into a partially decomposed agglomeration of chips, stringy bark, and fine pieces. The production of compost and topsoil involves collecting organic material, such as from food processors and livestock operations, for example, and repeatedly mixing the collected material throughout the decomposition process until it reaches the desired level of decomposition for a given application.

Bulk materials, such as mulch, organic compost, granulated rock salt and other deicers, sand, and gravel, are commonly transferred to a work site by a truck, such as a dump bed truck or a flatbed stake body truck, or by another similar transport vehicle.

Although the landscape maintenance industry is generally labor-intensive, bulk material handling, in particular the handling of mulch and compost, is considered especially demanding because it is most frequently carried out on completed lawn and landscape garden areas. Therefore heavy construction equipment, such as front end loader type devices, is generally not practical for bulk material handling due to the risk of damaging the existings lawn and landscape gardening areas. As a result, much of the work must be performed by individual workers, and the nature of the work presents challenges. Mulch, compost, and topsoil can all carry a high water percentage (in excess of 20%), and therefore these materials can become quite heavy, especially when wet. In addition, these materials are typically transported around a worksite using wheelbarrows, carts, tubs, and other similar vehicles. Moving these vehicles can again be challenging if the materials are heavy. Moreoever, the materials must be loaded into the transport vehicles, and this loading is often accomplished scoop-by-scoop using a shovel or pitchfork. Decomposing mulch and compost can generate significant heat, thereby making their handling even more taxing.

Devices have been developed to assist in the handling and application of bulk materials, particularly mulch. One such category of devices is referred to as “mulch blowers”, even though these devices can be used for handling other materials as well. Such devices rely on a prime mover, a bulk material holding hopper, and a pressure generating blower such as a positive displacement blower. A conveyor feeds a rotary airlock, the airlock serving to meter portions of mulch, topsoil, or other organic materials into the air stream. The mulch, topsoil, or other organic materials are then carried down a hose which blows the material onto the ground in locations directed by the machine operator. Although the hose is an effective conduit for transporting material to the selected landscape bed, materials are typically blown outside of the desired area, such as onto sidewalks, parking areas, plant materials, and building portions near the planting beds. As a result, the use of a blower device often requires a secondary labor step of cleaning up the over-sprayed material.

Mulch blower devices come in a variety of sizes, and a particularly common size comes equipped with a small holding hopper which holds the material prior to discharging through the device's air stream. These small capacity machines can be quite expensive, but they are also cost-effective relative to larger blower models, which often require being mounted on a dedicated truck. Smaller capacity machines therefore eliminate the requirement for the landscape maintenance contractor to purchase larger truck mounted units which require a dedicated truck. Dedicated trucks for larger truck mounted blower units are often enough of a scale larger than what is owned by typical landscape and landscape maintenance contractors. The issue of a larger truck can also present problems designating a properly trained and licensed driver. Also, larger truck mounted units may be difficult to move on the job site. Despite the transportation and maneuverability advantages of smaller units, the limited volume of the hopper capacity decreases the device's labor-savings benefit because operators must continually reload the hopper. For example, a worker must stand in the back of a larger capacity vehicle such as a dump truck or a flatbed truck and transfer by shovel or pitchfork mulch from the truck bed into the hopper of a smaller unit. To eliminate this laborious transfer step, some contractors use a tractor with front end loader or skid steer loader. However, this additional piece of equipment adds ownership and maintenance costs, and requires additional resources for transporting it to the jobsite. Moreover, the specialized nature of mulch blowing machines comes with significant maintenance requirements, and the inevitable repairs. These repairs can be quite expensive. Despite these drawbacks, the acceptance of blowers in the marketplace validates the motivation landscape maintenance and installation companies have to reduce the labor demands faced when handling and distributing organic materials such as mulch, compost and topsoil.

Another type of known equipment can be described as a “mulch wagon”, which consists of a container capable of holding a volume of mulch, topsoil, or similar bulk material. Mulch wagons can typically include a conveyor means running longitudinally in the bottom of the container and then a transverse conveyor typically at the end, most commonly a front portion. The transverse conveyor directs material to an exit, where a user can receive the material. The mulch wagon may be actuated by a user operating an actuation lever, for example.

Although mulch wagon systems are effective at transporting a large volume of material to a job site, they provide no assistance in transferring material at the job site itself. Further, mulch wagons are expensive. The cost of either of several commercially available trailer-mounted mulch wagons far exceeds the cost of the vehicle that would typically tow the wagon. The capital cost is significant in and of itself, and is amplified significantly when considering that the installation of mulch and bulk materials in general is a seasonal and sporadic activity for landscapers and landscape maintenance companies. To transport material on the job site itself, the crew commonly transfers material by means of a handheld tub or wheelbarrow. And when available and possible given jobsite conditions, a tractor mounted loader bucket or certain types of specialized hopper devices intended to mount on commercial lawnmowers can be used. Such hopper devices require time and some adaptation to mount on the selected mower. They sit above the mower deck and the weight of the hopper and mulch content is carried by the casters on the front of the mower deck. Mower deck caster wheels have been designed to support the load of the mower deck without causing ruts in various surface soils and conditions, but the caster wheels were not necessarily designed to do so with an additional 500-1000 pounds of bulk material. However, mulch in particular, is frequently spread in the spring when the ground is often wet and soft, resulting in the formation of ruts created by the dramatically increased ground pressure due to the additional load on the mower deck caster wheels. Given that one of the primary objectives for installing mulch is beautification, creating anything more than an occasional rut is not considered to be an acceptable practice.

Organic fertilizing material (compost) is bulky, especially when compared to granulated or liquefied fertilizers, and three to five cubic yards of organic material may be required to fertilize or top dress the lawn and garden areas of a typical residence. As can be appreciated, the cubic volume required for large residences and commercial areas would be significantly greater than for smaller areas. Top dressing is a term of art used by lawn and landscape maintenance professionals to describe a process of spreading a relatively thin layer of organic material over the top of lawn and planting bed areas. Top dressing can be done by manually distributing the organic material, but is most often done through the use of a specialized machine called a top dresser. Top dressing machines include a hopper which feeds a drop or rotary type distribution component. Loading the hopper, especially when working in residential environments typically involves scooping the material out of the back of a truck with a shovel or the like and filling the hopper. During the course of fertilizing or top dressing a residential lawn and landscape area, the hopper may need to be refilled five to ten times, or even more. While the use of top dressing with organic fertilizing material as a substitute for chemical fertilizers has environmental benefits that are desirable to some consumers, the labor-intensive process for loading it into a top dresser's hopper requires considerable time and effort that translates into costs. This can make organic fertilizing methods more expensive than conventional chemical fertilizers.

Landscape company operators are also commonly engaged in the business of snow and ice control using a variety of specialized equipment. More specifically, bulk granulated salt, rock salt, sand, and combinations thereof are distributed onto roadways, parking areas, and sidewalks. Hopper type tailgate spreaders attached to a tailgate portion of a pickup truck or a pickup truck's trailer hitch receiver have relatively small capacity. For increased productivity larger capacity boxes referred to as “V boxes” can be inserted into the bed of stout trucks. V box spreaders come in a variety of sizes, such as those sized for the maintenance of commercial parking lots and those sized for the maintenance of public streets and interstate highways. Those sized for commercial parking lots typically hold one to two cubic yards of bulk material whereas those sized for large commercial parking lots, public streets and interstates hold more than cubic yards. V box spreaders include a v-shaped hopper, which is desirable for funneling material onto a conveyor which delivers the material to a rotating disk that casts the material over the surface to be treated. However, the shape of the v-shaped hopper results in elevating the truck's center of gravity which to some extent limits the weight of material that the truck can safely transport. As the V box extends up not only is the volume of material at an increased elevation, but continuing higher begins to present a risk of the V box hitting overhead obstructions. More significantly, the funneling geometry of the v-shaped box reduces the total volume of material that the truck can transport, as compared with a regular truck bed. In order for the material to flow, the angle of the v shape can be quite steep. This limitation on capacity results in more frequent returns to the restocking location. Frequent restocking reduces productivity at a time when maintenance crews are trying to treat parking areas and roads.

Transverse conveyors are another category of salt spreading devices. Transverse conveyors can replace the tailgate of 1 ton or larger dual wheel trucks or if the truck has a top pivoting tailgate, can mount below the tailgate of such truck types. These devices have limited popularity for distributing bulk snow and ice control material because they often require the truck to be driven with the bed raised in order to deliver a continuous flow of bulk material to the conveyor. Such systems distribute material onto a conveyor and/or then onto a rotary disk, which spreads the material as the vehicle drives over the surface to be treated. Although not as expensive as the systems for handling bulk mulch, these salt delivery systems also only have a seasonal use. Throughout the off-season, which in many areas is the vast majority of the year, they sit idle and are often subject to the weather if stored outdoors or consume indoor storage space and this lack of use results in a certain amount of wear and annual maintenance. For example, water can get into bearing assemblies and rust can form on the exposed surfaces of idle bearings. In addition, mechanical linkages can become rusty or stiff from nonuse. Although an accepted practice, there is a cost and certain level of inconvenience associated with seasonal refurbishment of these devices.

Particularly in the fall, there is a need to collect and transport leaves. Known devices include container attached to trucks with stake body and dump type beds. Commercially available devices are available, but present the landscape company operators with the additional expense from the purchase of a leaf container, seasonal installation and removal from the truck, and periodic maintenance thereof. Moreover snow or ice can accumulate late in the fall or early in the spring when the landscape company operator could have configured their truck for leaf collection and they may use this same truck for snow removal. Removing the leaf container and replacing with a device for distributing salt can incur a labor expense.

Thus, a need exists for improved bulk material handling devices.

### SUMMARY OF THE INVENTION

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, the modular bulk material unloading and distribution system includes a power means. The powered conveyor apparatus includes a pressurized fluid means in the form of a power unit having at least capability of rotating a hydraulic motor. A conveyor assembly cooperating with a portion of a dump truck body the conveyor comprises at least one wing proximate the conveyor belt frame and said wing being foldable so that when the dump bed is raised the wing is capable of directing bulk material to the conveyor assembly. The conveyor assembly is then capable of transferring bulk material into the container. The wing is folded to abut the bed side of the truck to establish a maximum opening angle and to divert the bulk material to the conveyor. In a variant, there is an extension wing component capable of folding out to prevent bulk material from overrunning outer edge of the wing as it is folded up from a flat position to a more vertically angled position.

In accordance with another embodiment a conveyor belt is powered via a direct drive means such as through belts, chains connected to pulleys or sprockets with the prime mover being an internal combustion motor

In accordance with another embodiment the conveyor belt assembly is cooperating with a portion of a dump truck body transfers bulk material to a second horizontal conveyor for subsequent deposit of said bulk material into the hopper of a mulch blower.

In accordance with another embodiment of the invention, the conveyor belt is powered by a hydraulic motor which derives its power from pressure created by the mulch blower's hydraulic system.

In accordance with another embodiment the conveyor belt assembly cooperating with a portion of the dump truck body and the conveyor belt itself is rotating the conveyor belt at a sufficient foot per minute such that bulk material being discharged from the tip of the conveyor belt is cast into the hopper of a mulch blower.

In accordance with another embodiment, an attachment bracket assembly includes at least a single ground engaging flotation foot assemblies having a front height adjust rod cooperating with a welded height adjustment means. A front cross support and a front support slider connects the flotation foot assembly. A pair of rear support foot can include a rear height adjust rod, a tubing engagement channel, a rubber protective surface and a flared foot. A rear cross support and a rear support slider connects the rear support. The universal attachment bracket is connected to a hopper via a hopper attachment.

In accordance with another embodiment, the dump bed is tilted at an angle to transfer the flowable bulk materials into a hopper connected to the universal attachment bracket assembly.

In accordance with another embodiment the hopper connected to the universal attachment bracket is attached such that the discharge end of the hopper can be pivoted vertically relative to the hopper's opposite end.

In accordance with another embodiment, the dump bed is tilted at an angle to transfer the flowable bulk materials to a tailgate type salt spreader. Said tailgate type spreader could be attached to the tailgate of the truck or alternatively attached proximate the tailgate of the truck with the use of a securing bracket configured to cooperate with the trucks trailer hitch

In accordance with another embodiment, the conveyor assembly lies flat in the truck bed and has at least one wing which directs material to the conveyor which transfers material to a hopper.

In accordance with another embodiment, the conveyor assembly lying flat in the truck bed can be fitted at the rearmost portion with a snow and ice control distribution component comprising at least a rotary disk.

In accordance with another embodiment, the conveyor assembly lying flat in the truck bed includes at least one wing paralleling the longitudinal axis of the conveyor assembly. Said wing moving from a first position wherein they are generally flat against the bed of the truck to a second angled or lifted position such that a wing is capable of diverting bulk material from the wing surface to the conveyor surface. A salt distribution component is fitted onto the rearmost end of the conveyor assembly or rear containment panel so that the reconfigured device can function as a V-box type salt spreader.

In accordance with another embodiment, the conveyor assembly lying flat in the truck bed includes at least one wing paralleling the longitudinal axis of the conveyor assembly. The embodiment further includes a wall panel receiving member on a portion of the device wing or alternatively the receiving member could extend from the conveyor frame or from the truck bed itself. Said receiving member and wall panel in conjunction with a roof panel form an enclosure over the flatbed conveyor assembly. The rear panel of the flatbed conveyor assembly further includes a blower vacuum assembly. Said blower vacuum assembly having a discharge pipe exiting into an aperture within an upper portion of one of the wall panels. When configured as described, the device can serve as an apparatus for the collection and transport of leaves.

In accordance with another embodiment, the conveyor assembly lying flat in the truck bed includes at least one wings paralleling the longitudinal axis of the conveyor assembly and including at least a rear containment panel including an opening aligned with the discharge end of the conveyor. The at least 1 wing panel including a wing containment panel fixed to at least the end proximate the discharge end of the conveyor. When the wing is in a flat lying position, the rear containment panel and the wing containment panel form a continuous panel capable of retaining bulk material and further, when the wing panel is moved from a flat lying position to an angled position the wing containment panel is capable of overlying a portion of the rear containment panel while maintaining partial opening of the rear containment panel.

Various additional features and advantages of the invention will become more apparent to those of ordinary skill in the art upon review of the following detailed description of the illustrative embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 shows a perspective view of a truck having a dump-type bed and containing a load of bulk material.

FIG. 2 shows a perspective view of a bulk material unloading system constructed according to a first embodiment of the present invention.

FIG. 3 shows a perspective view of a bulk material unloading system constructed according to a second embodiment of the present invention.

FIG. 4 shows a perspective view of a bulk material unloading system constructed according to a third embodiment of the present invention.

FIG. 5 shows an elevational view of the bulk material unloading system of FIG. 4.

FIG. 6 shows a perspective view of a bulk material unloading system constructed according to a fourth embodiment of the present invention.

FIG. 6A shows an alternative winch arrangement for the bulk material unloading system of FIG. 6.

FIG. 7 shows a perspective view of the bulk material unloading system of FIG. 6 in a truck bed, with its material directing wings in a raised position.

FIG. 8 shows a perspective view of an attachment bracket constructed according to a fifth embodiment of the present invention.

FIG. 9 shows a perspective view of a bulk material unloading system attached to a mower and constructed according to a sixth embodiment of the present invention.

FIG. 10 shows a perspective view of a flotation foot assembly constructed according to a seventh embodiment of the present invention.

FIG. 11 shows a side partial cutaway view of a bulk material unloading system constructed according to an eighth embodiment of the present invention.

FIG. 12 shows a perspective view of the bulk material unloading system of FIG. 11 attached to a mower.

FIGS. 13, 14, and 15 show views of the bulk material unloading system of FIG. 11 attached to a mower and pivoted to adjust the discharge height of bulk material exiting the bulk material distribution system.

FIG. 16 shows a perspective view of the bulk material unloading system of FIG. 11 attached to a mower and including a rotary spreader.

FIG. 17 shows a partially exploded view of the bulk material unloading system of FIG. 16.

FIG. 18 shows the bulk material unloading system of FIG. 11, mounted to the rear gate of a truck, and including a rotary spreader.

FIG. 19 shows a partially exploded view of the bulk material unloading system of FIG. 18, and provides additional detail with respect to the tailgate and mounting bracket.

FIG. 20 shows a rear perspective view of a bulk material unloading system attached to a mower and constructed according to a ninth embodiment of the present invention.

FIGS. 21 and 22 show two configurations of a wing geometry according to a tenth embodiment of the present invention.

FIG. 23 shows a perspective view of a bulk material unloading system constructed according to an eleventh embodiment of the present invention and including a bulk material dispersion device in a first position, engaging bulk material.

FIG. 24 shows a perspective view of the bulk material unloading system of FIG. 23, with the bulk material dispersion device in a second position, not engaging bulk material.

FIG. 25 shows a cross-sectional view depicting features of the bulk material dispersion device of FIGS. 23 and 24.

FIG. 26 shows a bottom plan view depicting features of the bulk material dispersion device of FIGS. 23 and 24.

FIG. 27 shows a perspective view of a leaf collection attachment assembly constructed according a twelfth embodiment of the present invention.

FIG. 28 shows an exploded view of some of the features of the leaf collection attachment assembly of FIG. 27.

FIG. 29 shows a top perspective front view of a bulk material unloading system constructed according to a thirteenth embodiment of the present invention, including an optional secondary conveyor assembly.

FIG. 30 shows a bottom perspective back view of the bulk material unloading system of FIG. 29.

FIGS. 31-34 shows schematic depictions of a bulk material unloading system constructed according to a fourteenth embodiment of the present invention and being used to unload material into a hopper.

FIG. 35 shows a schematic perspective view of a bulk material unloading system constructed according to a fifteenth embodiment of the present invention and including a single wing.

FIG. 36 shows a perspective view of a bulk material unloading system, in a transport configuration, according to a sixteenth embodiment of the present invention.

FIG. 37 shows a perspective view of the bulk material unloading system of FIG. 36, inclined in an operating configuration.

FIG. 38 shows a top plan view of the bulk material unloading system of FIG. 36, depicting the wings as moveable with respect to the conveyor assembly.

FIGS. 39A-39C show schematic views of a bulk material unloading system constructed according to a seventeenth embodiment of the present invention and including a transverse conveyor assembly.

FIGS. 40 and 40A show schematic perspective views of a bulk material unloading system constructed according to an eighteenth embodiment of the present invention and including a power pack device.

FIG. 41 shows a perspective view of a bulk material unloading system, in a transport configuration, according to a nineteenth embodiment of the present invention.

FIG. 42 shows an exploded view of the bulk material unloading system of FIG. 41.

FIG. 43 shows a rear partial cutaway view of the bulk material unloading system of FIG. 41.

FIG. 44 shows a perspective view of the bulk material unloading system of FIG. 41.

FIGS. 44, 45, and 46 show elevational views of the bulk material unloading system of FIG. 41.

FIG. 47 shows a perspective view of a bulk material unloading system, according to a twentieth embodiment of the present invention, in a first position.

FIG. 48 shows the bulk material unloading system of FIG. 47 in a second position.

### DETAILED DESCRIPTION OF ILLUSTRATIVE EMBODIMENTS

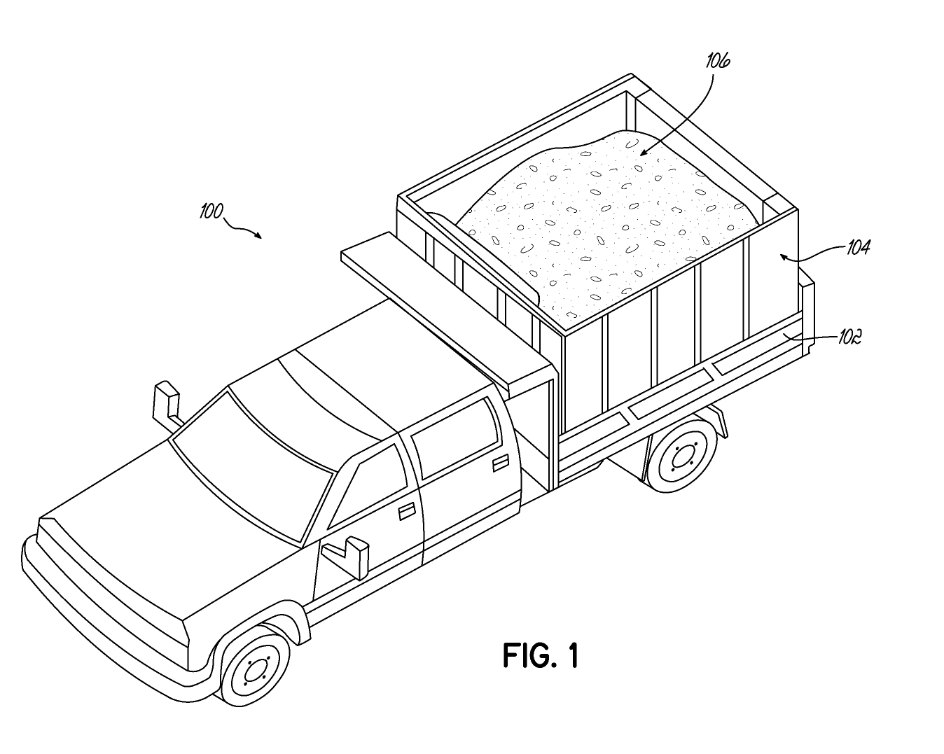

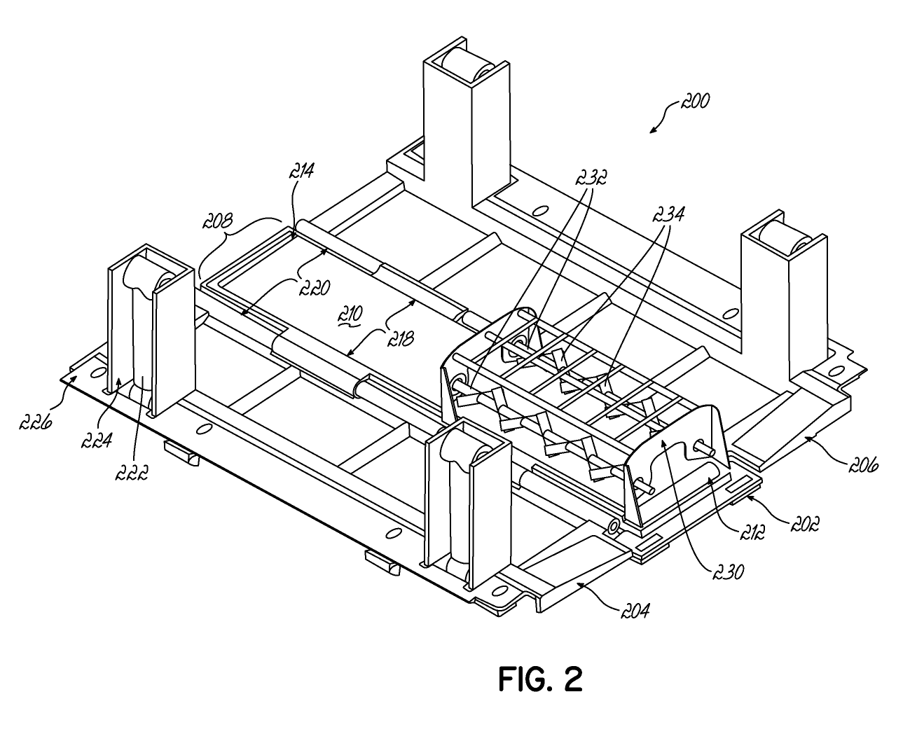

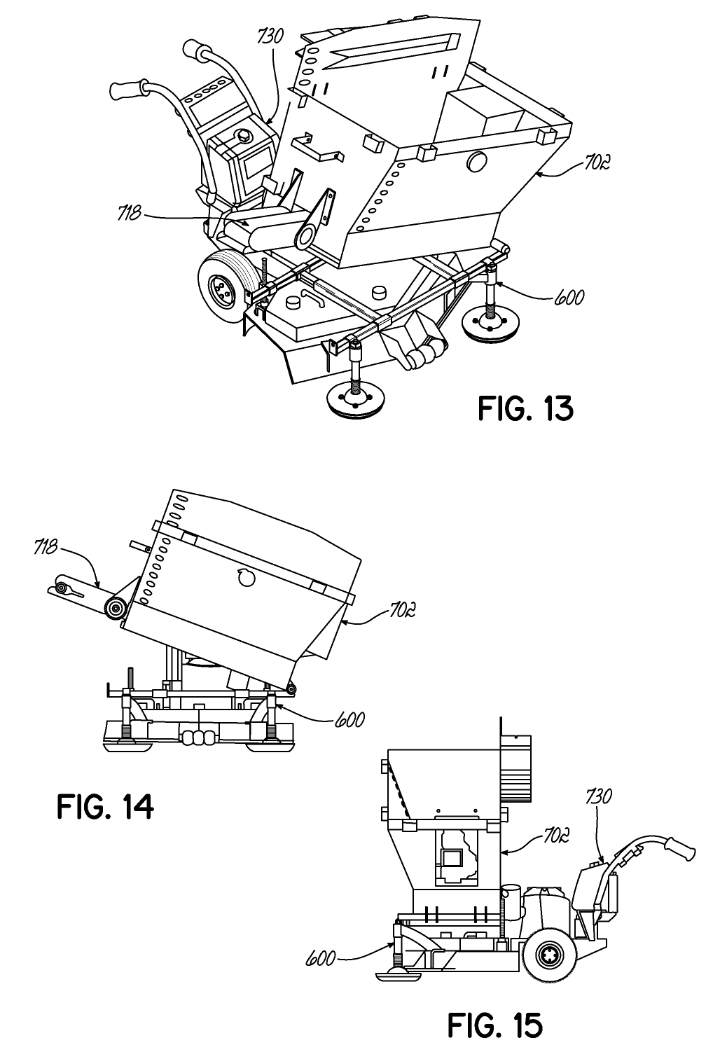

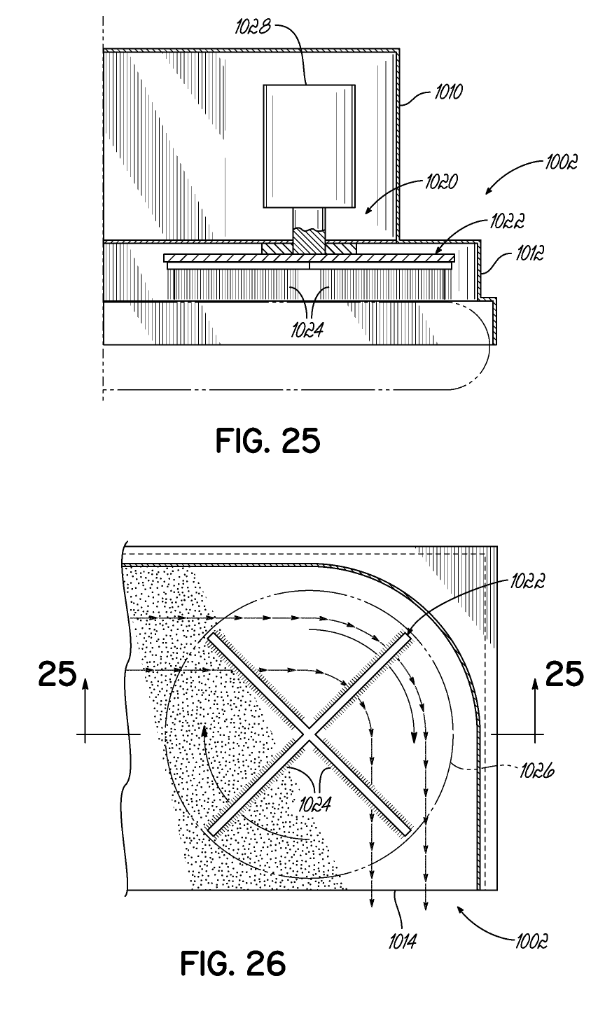

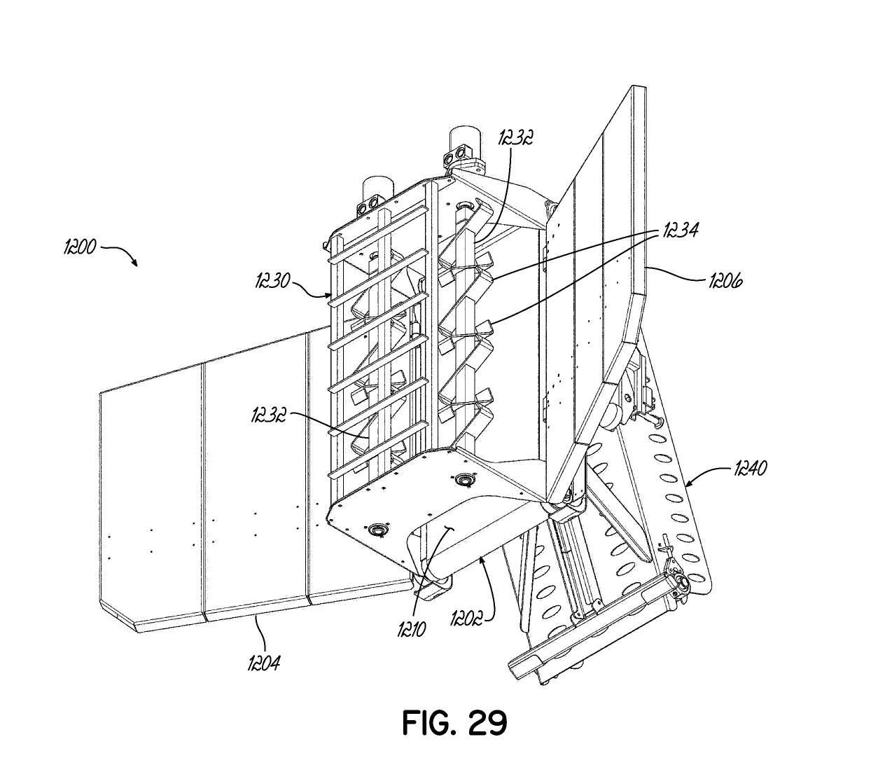

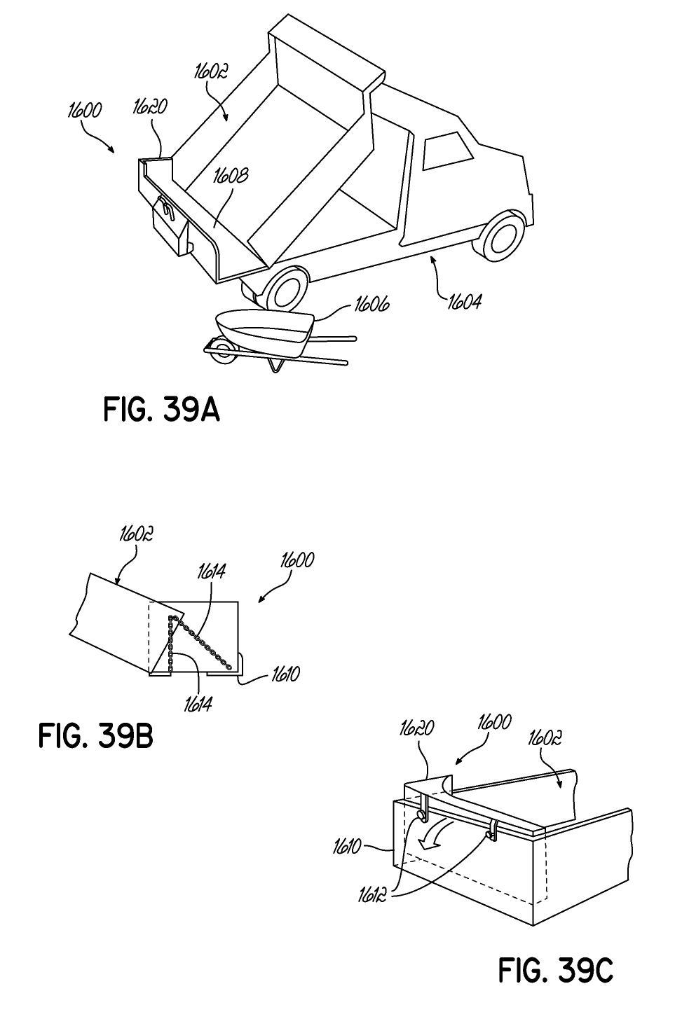

Referring now to the figures, several bulk material unloading systems, and related devices, are shown. These systems are useful for unloading and distributing bulk materials, such as mulch, organic compost, granulated rock salt and other deicers, sand, gravel, and the like. FIG. 1 depicts the typical context for which the systems are useful—a truckload of bulk material. FIGS. 2-28 generally depict various bulk material unloading systems that are generally used with their conveyor assemblies in horizontal orientations. FIGS. 29-38, in turn, depict various bulk material unloading systems that are generally used with their conveyor assemblies in raised, non-horizontal, orientations. FIGS. 39-48, in turn, depict various other bulk material unloading systems.

Beginning with FIG. 1, a truck 100 is shown and includes a dump-style bed 102. The bed 102 holds a container 104 of bulk material 106. The bulk material 106 can include mulch, organic compost, granulated rock salt and other deicers, sand, gravel, and the like, and requires unloading and/or distribution from the truck 100. As will be evident from the following description, the various devices disclosed herein are useful for unloading and distributing bulk material.

FIG. 2 depicts a bulk material unloading system 200 in accordance with one embodiment of the invention. The bulk material unloading system 200 generally includes a conveyor assembly 202 between two moveable wings 204, 206. Other connections between the wings 204, 206 and the conveyor assembly 202 could also be employed such as tabs extending from one of the wings engaging a portion of the conveyor assembly sufficient to maintain connection through wing's range of travel. It is also possible that containment of the unloading system 200 by the bed of a truck could restrict movement of the wings 204, 206 away from the conveyor such that a movable connection point is not required. The conveyor assembly 202 includes a conveying device 208, which in the embodiment shown includes a planar endless conveyor belt 210. The conveyor belt 210 can be used to transport bulk material, such as bulk material 106. Of course, other types of conveying devices can be used, such as such as screw, vibratory, drag chain, bucket wheel, air or flicker devices. Also, a single wing could be used, rather than two.

The conveyor assembly 202 includes a drive pulley 212 and a driven pulley 214 which provide for the conveying movement of the conveyor belt 210. A belt tensioning device can also be included (not shown), such as to adjust the tension on the belt or the belt tracking so that the conveyor belt 210 itself stays aligned with the pulleys 212, 214 and does not “run off”. The conveyor assembly 202 can be driven by any appropriate means, such as a hydraulic motor driving the driven pulley 214. The conveyor assembly 202 can be driven in either direction, such that bulk material can be discharged from either end of the conveyor belt 210.

The wings 204, 206 are moveably connected with the conveyor assembly 202. For example, in the embodiment shown, hinge knuckles 218 on the conveyor assembly mate with hinge knuckles 220 on inboard regions of the wings 204, 206. The wings 204, 206 are independently moveable through a range of angles with respect to the conveyor assembly 202. For example, the wings 204, 206 can be generally parallel with the conveyor belt 210 (as shown in FIG. 2). The wings 204, 206 are also pivotably moveable with respect to the conveyor assembly 202, such as by raising either or both of the wings 204, 206. When the wings 204, 206 are in the orientation shown in FIG. 2, a greater amount of bulk material can be stored above the wings 204, 206 as compared with known V box spreaders, and carry the bulk material at a lower center of gravity.

The wings 204, 206 can be moved using a lifting device. In the embodiment shown, a lifting device is provided in the form of hydraulic lift mechanisms 222. The hydraulic lift mechanisms 222 are connected to the wings 204, 206 at generally outboard regions thereof. The hydraulic lift mechanisms 222 are supported within, and pivotably connected to, cylinder support towers 224. The cylinder support towers 224 are also connected with the wings 204, 206. The hydraulic lift mechanisms 222 are powered by an appropriate source of hydraulic fluid power, or any other appropriate source of power.

The wings 204, 206 optionally include wing flaps 226 positioned at outboard ends thereof. The wing flaps 226 may be useful, for example, for scraping along an interior wall of a container housing the unloading system 200, such as a bed wall of a truck. As the wings 204, 206 are moved upwardly, the wing flaps 226 will tend to scrape along a surface of the interior wall and ensure that bulk material does not fall under the wings 204, 206.

The unloading system 200 optionally includes a modular conditioner assembly 230 for agitating bulk material as it is moved along the conveyor belt 210. The conditioner assembly 230 includes a pair of agitating bars 232 each having a plurality of agitating protrusions 234. The agitating bars 232 extend generally parallel with, and the agitating protrusions extend generally perpendicular with, the direction of movement of the conveyor belt 210. The agitating bars 232 are driven to rotate so as to engage and agitate bulk material on the conveyor belt 210. The conditioner assembly 230 can be driven by an appropriate source of power. Other configurations for the conditioner assembly 230 are also possible, such as a single agitating bar 232 could be used instead of two, or more than two could be used, and the direction of the agitating bars 232 with respect to the direction of movement of the conveyor belt could be different.

The unloading system 200 may be used in several environments. For example, the unloading system 200 could be situated in the bed of a truck, such as the bed 102 of the truck 100 shown in FIG. 100. The unloading system 200 could also be secured to the bed of a stake body type truck, or to a flatbed trailer, as appropriate.

The unloading system 200, including the optional conditioner assembly 230, can be operated by an appropriate means. For example, the unloading system 200 be operated by manual engagement of a lever or by electronic or passive mechanical means. Certain types of bulk material or operator preference may make it desirable to initiate rotation of the agitating bars 232 just prior to movement of the conveyor belt 210. Or, rotation of the agitating bars 232 may be delayed until just prior to discharge of the bulk material from the conveyor belt 210. For instance the bulk material may contain undesirable clumps that the conditioner assembly 230 could break up, or it may be desirable to slightly verify the bulk material by mixing it with the conditioner assembly 230.

The unloading system 200 may be used to deposit bulk material into a hopper, a wheelbarrow, or other container suitable for the transfer of the bulk material. As the quantity of the bulk material is depleted an operator may move the wings 204, 206 to lift and direct remaining bulk material toward the conveyor belt 210. For example, the operator might actuate a lever that causes fluid power to pass to the hydraulic lift mechanism 222 which raises one or both of the wings 204, 206. The bulk material on the wings 204, 206 is thereby directed toward the conveyor belt 210, by which it can be further transferred. The wings 204, 206 can be operated at the same time as the conveyor belt 210 is moving, or while the conveyor belt 210 is stopped. For example, bulk material can be moved off of the conveyor belt 210 before the wings 204, 206 are moved. This method of clearing bulk material off of the conveyor belt 210 and then depositing more material on to the conveyor belt by moving the wings 204, 206 allows the overall system 200 to function with less energy than would be the case if a wing 204, 206 moved at the same time as the conveyor belt or multiple wings 204, 206 moved at the same time as the conveyor belt 210. Similarly, the conditioner assembly 230 can be actuated and stopped in any appropriate or desirable manner, such as at the same time as movement of the conveyor belt 210, while the conveyor belt is stopped, while the wings 204, 206 are moving, or while the wings 204, 206 are stationary. The ability to stagger the power requirements through the use of electronics, hydraulic circuits or electric circuits may be desirable if any of the components of the unloading system 200 are directly or indirectly powered from a source of power shared with a vehicle, such as a truck, or as may be desirable through the use of low horsepower mechanical or hydraulic power units.

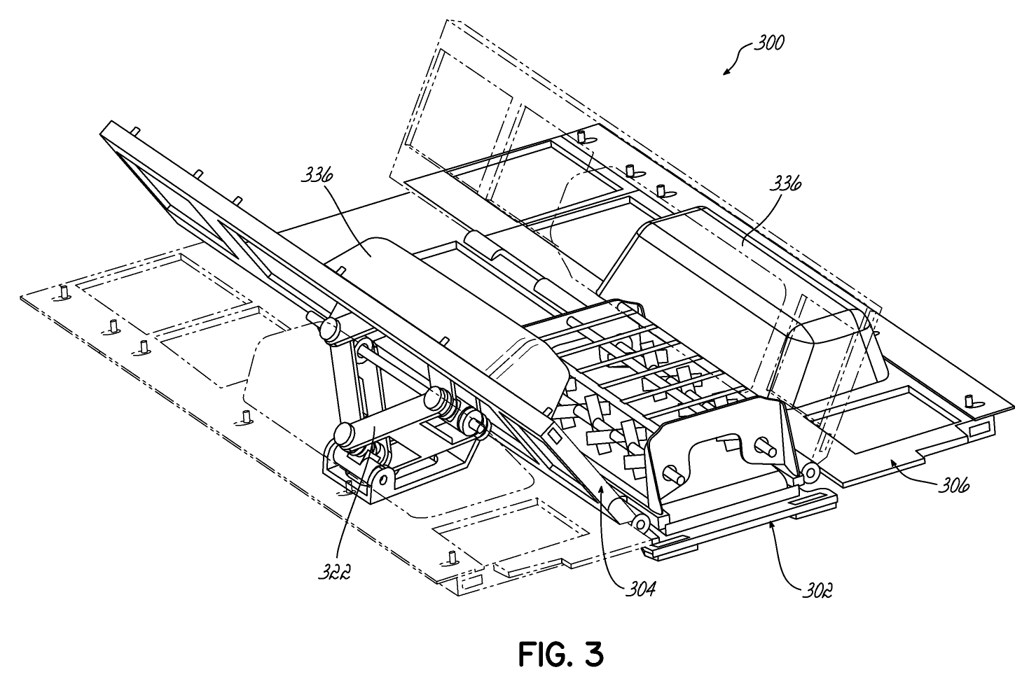

FIG. 3 depicts a bulk material unloading system 300 in accordance with one embodiment of the invention that is generally similar to the unloading system 200, but includes scissor jack assemblies 322 as lifting devices for moving wings 304, 306 with respect to the conveyor assembly 302. The scissor jack assemblies 322 are an alternative to the hydraulic lift mechanisms 222 shown in FIG. 2, and are optionally removable from the wings 304, 306. While FIG. 2 shows the wings in a collapsed or flat position, FIG. 3 illustrates the wings in a lifted position. The scissor jack assemblies reside in humps 336 formed in the wings 304, 306. The scissor jack assemblies 322 can be operated in any appropriate manner to move the wings 304, 306 with respect to the conveyor assembly 302. Generally, regardless of the mechanisms 222, 322, the wings are selectively moveable between the collapsed position (FIG. 2) and the lifted position (FIG. 3).

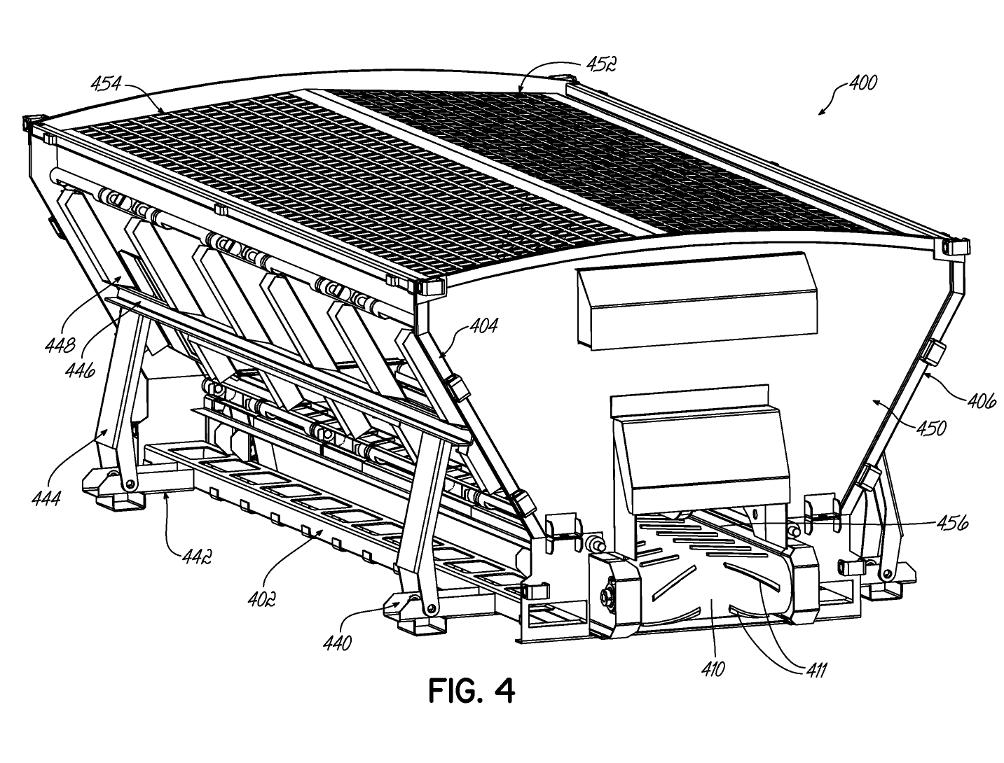

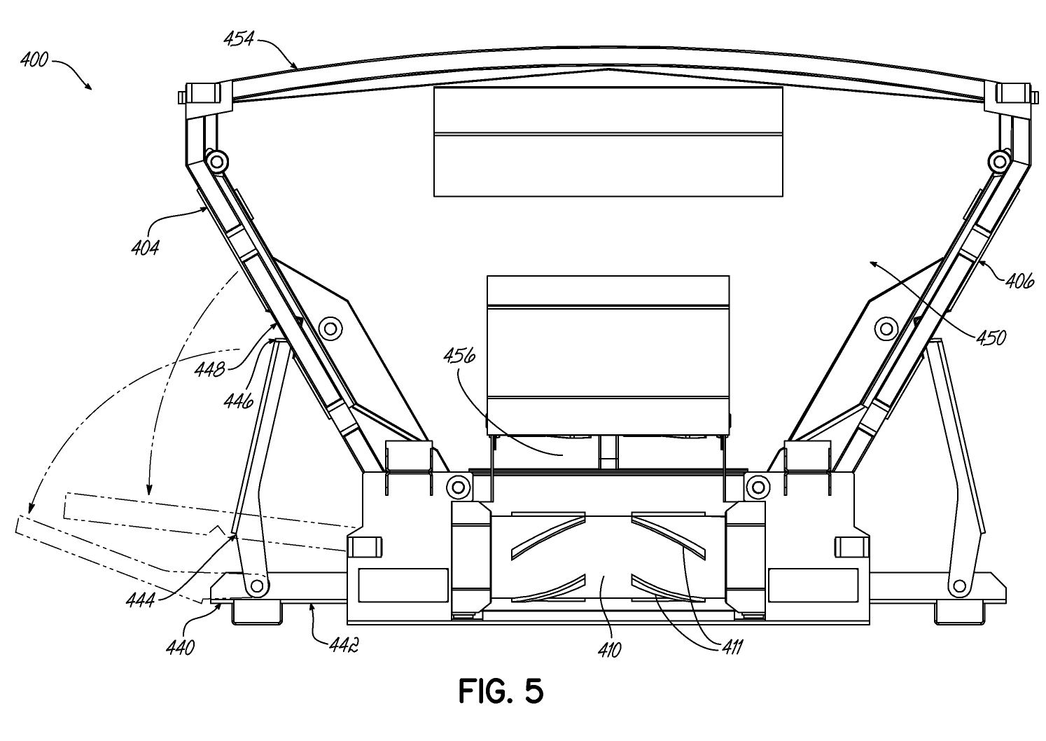

FIGS. 4 and 5 depict a bulk material unloading system 400 in accordance with one embodiment of the invention. The unloading system 400 is generally similar to the unloading systems 200, 300, but does not include a lifting device for moving its wings 404, 406. Instead, the unloading system 400 includes pivoting wing support brackets 440 that extend from the conveyor assembly 402. The support brackets 440 include a first stationary section 442 that extends from the conveyor assembly 402 and a second pivoting section 444 pivotably coupled with the first section 442. The second section 444 includes a support end 446 that is configured to reside in a notch 448 formed on the underside of the wings 404, 406. When it is desirable to raise the wings 404, 406, they are moved with respect to the conveyor assembly 402 to an upwardly angled or lifted position, and the wing support brackets 440 are moved into supporting engagement with the wings 404, 406. Particularly, the support ends 446 are put into supporting engagement with the notches 448. Alternatively, when it is desirable to lower the wings 404, 406, the wing support brackets 440 are moved out of supporting engagement with the wings 404, 406, so that the support ends 446 are not in supporting engagement with the notches 448, allowing the wings 404, 406 to be lowered.

In addition, the unloading system 400 includes front and rear material retention panels 450, 452, respectively. The retention panels are coupled with the wings 404, 406 so as to form a hopper configuration, as shown. An optional cover member 454 covers the hopper, spanning between the retention panels 450, 452 in the front-back direction and between the wings 404, 406 in the side-side direction. The front retention panel 450 includes an opening 456 configured to allow bulk material to be carried out of the hopper configuration formed by the retention panels 450, 452 and the wings 404, 406. As shown, the conveyor belt 410 extends slightly beyond the front retention panel 450, so as to deliver bulk material out of the hopper configuration at a point beyond the front retention panel 450.

Moreover, the unloading system 400 includes a conveyor belt 410 having optional lugs 411. The lugs 411 can provide improved engagement with certain types of bulk material.

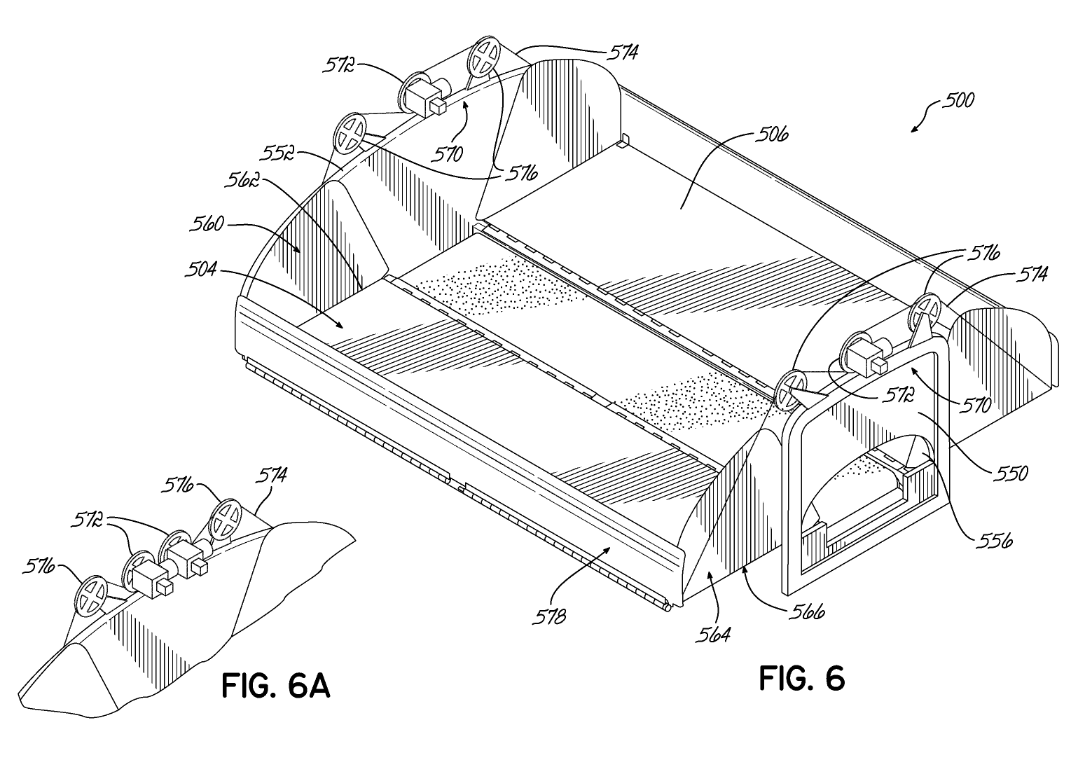

FIGS. 6, 6A, and 7 show a bulk material unloading system 500 in accordance with one embodiment of the invention. The unloading system 500 is generally similar to the unloading systems 200, 300, and 400. The unloading system 500 includes wings 504, 506, and front and rear material retention panels 550, 552. The rear material retention panel 552 is generally solid (and in some embodiments, optional), and the front material retention panel 550 includes an opening 556 for allowing bulk material to pass through. In addition, the wings 504, 506 include rear panel leafs 560 extending upwardly along a rear edge 562 thereof, and front panel leafs 564 extending upwardly along a forward edge 566 thereof.

Winch assemblies are provided for moving the wings 504, 506 between the down position and the up or lifted position. Alternative winch assembly designs are shown in FIGS. 6 and 6A. A winch assembly 570 is provided in FIG. 6 at both the front and rear ends, and is supported on the material retention panels 550, 552. The winch assemblies 570 may also be supported by a separate winch assembly support panel. Each winch assembly 570 includes a motor driven sprocket 572 that is connected with winching cables 574, with one winching cable each per wing 504, 506. The winching cables 574 are trained around pulleys 576 and are connected with the wings 504, 506 near the outboard regions of the front and rear edges 566, 562. In FIG. 6, a single sprocket 572 is associated with the two wings 504, 506, in a so-called bi-directional winch configuration. An alternative configuration is shown in FIG. 6A, where a sprocket 572 is associated with only one wing 504, 506.

To move the wings with respect to the conveyor assembly 502, the winch assemblies are caused to rotate the sprockets 572 in an appropriate direction, whereby the winching cables either pull up or let down the wings 504, 506 between the down or collapsed position and the up or lifted position.

Optionally, the wings 504, 506 can include upstanding wing extension members 578 along the outboard sides thereof, as shown in FIG. 6, with the wings in the down position. Further, upstanding wing extension members, such as 578 could be adapted for use on any of the unloading systems, 200, 300 or 400. In addition, the upstanding wing members can include a torsion spring component or other stop mechanism to prevent gravity or the weight of bulk material to cause the hingedly connected upstanding wing extension members to fold back upon themselves. It is desirable for containment of the bulk material for the wing extension members through the orientation of the stop tab or torsion spring to hold the wing extension members remain at an angle no less than that of the wings.

The unloading system 500 can be put into the bed of a truck, as shown in FIG. 7. FIG. 7 illustrates wings in the up position. The unloading system 500 can be configured with a salt snow and ice control spreader assembly.

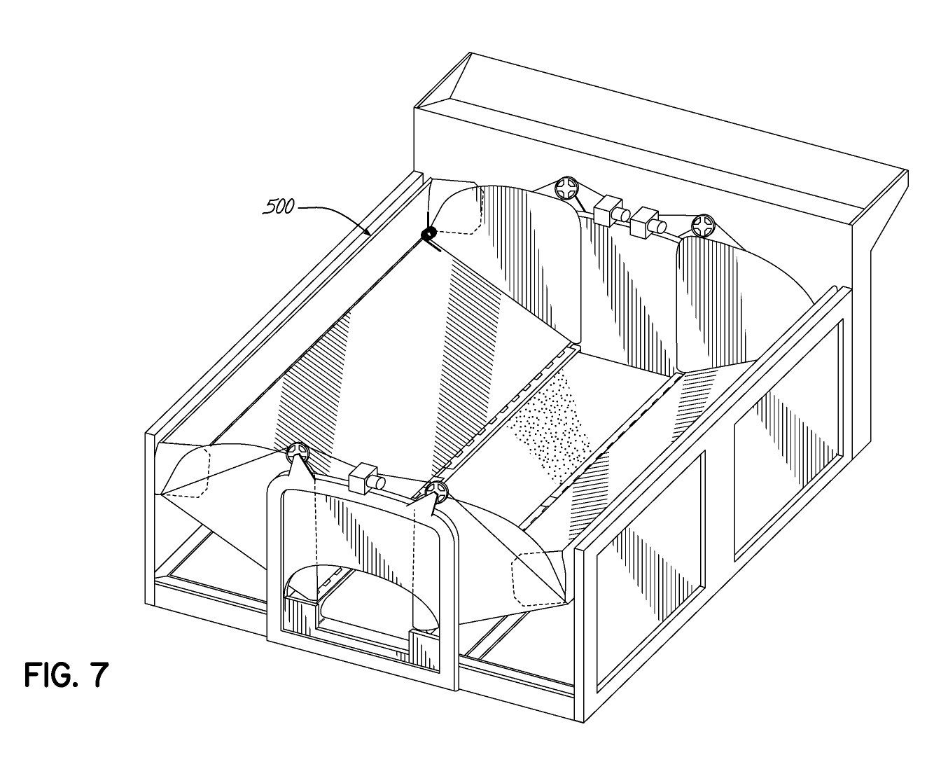

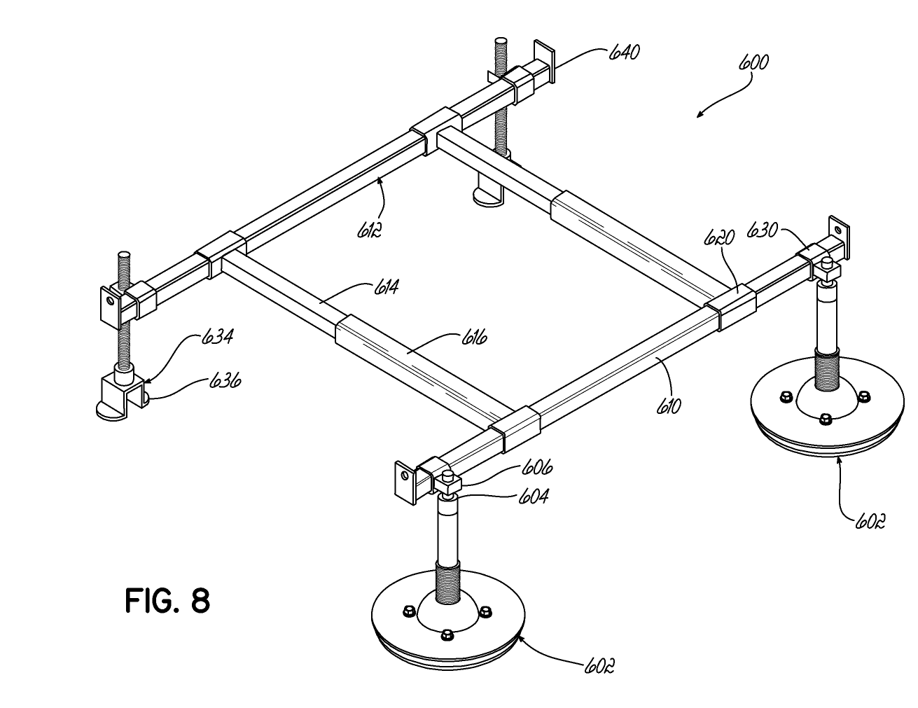

FIG. 8 depicts a universal attachment bracket 600 in accordance with one embodiment of the invention and configured for connecting a bulk material distribution or unloading system to another vehicle. The attachment bracket 600 includes an optional pair of flotation foot assemblies 602 having a threaded front height adjust rod 604 and a retention nut 606. If the optional flotation foot assembly 602 is not used, the retention nut 606 may be dimensioned to attach to the stem of a caster assembly. When it is necessary to attach retention nut 606 to a caster assembly, because caster stems fall within a range of dimensions, the retention nut 606 may have to be sized to accommodate the diameter of the largest stem and then the system is furnished with several sizes of bushings to allow the retention nut 606 to be securely attached to caster stems of lesser diameters. In an alternative design, the retention nut 606 could take the form of several sizes to correspond for engagement with a variety of caster stem diameters. If the optional flotation assembly 602 is used, the retention nut 606 is dimensioned to cooperate with the height adjustment rod 604. The thread pattern on the retention nut 606 matches the bolt thread pattern on the height adjustment rod 604. However, recognizing the range of diameters for caster stems, the height adjustment rod 604 is sized to mate with several sizes through use of an adapter bushing. The aforementioned caster stem fits into a generally tubular caster stem yoke member. Therefore when the caster stem diameter changes, so too does the yoke such that the two components can cooperate to form a snug fit with the caster stem yoke tube. The fit is such that the respective components can rotate relative to each other very tight rotational fit. The adapter bushing in its plurality of sizes will have an inside diameter and thread pattern that mates with the adapter bushing and an outside diameter that mates with the inside diameter of any given size of a yoke tube.

Commercial lawnmowers come in a variety of configurations: zero turn riding mowers, standing type riding mowers, and wide area walk-behind mowers are particularly common. Some mowers have floating decks whereas others have fixed decks and manufacturers offer both of these types in a variety of widths e.g., 36″, 48″, 52″ and 60″ for example. Furthermore, mowers are produced by over a dozen manufacturers. All of these variables require the universal attachment bracket assembly 600 to be readily adaptable to the physical conditions present on a wide range of mower chassis and mower decks. This is accomplished by an attachment bracket that is capable of adjusting its width, depth and height. Such adaptability allows the bracket assembly 600 to locate some of several attachment points, and to the wide variety of commercial mowers. And the range of with depth and height adjustment within universal attachment bracket 600 allows the bracket to be configured for engagement with the common attachment points while at the same time clearing any of a variety of obstructions on the mower deck or chassis that would otherwise interfere with attachment of a bracket that had less adjustment capability. As shown, the attachment bracket has a front cross support 610 and a rear cross support 612. The cross support members 610 and 612 run parallel with the width of the lawnmower deck and are connected to each other by means of an adjustable depth center support rear 614 and an adjustable depth center support front 616. The adjustable depth center support rear 614 is a tubular member that has an outside diameter marginally less than the inside diameter of adjustable depth center support front 616 which is also a tubular member. The relative difference in depth between the adjustable depth center support rear 614 and the adjustable depth center support 616 allows for telescopic engagement of the two members. This telescopic engagement allows the depth of the attachment bracket 600 to be increased or decreased in response to the size and configuration of the mower chassis or deck that the attachment system is attached to. Once the proper depth is selected a retainer pin or other locking mechanism is placed in a line of bull apertures within a wall of the adjustable depth center support rear 614 and the adjustable depth center support front 616. The increment of adjustment is dictated by the spacing of the apertures, though other configurations are implemented that can provide incident adjustment of distance between the rear cross support 612 and the front cross support 610.

The universal attachment bracket's width adjustment is derived through a front support slider 620 which is a tubular member having an inside diameter that is slightly greater than the outside diameter of the front cross support 610. The relationship of the inside diameter and outside diameter of the respective components is such that the front support slider 620 is capable of moving back and forth laterally on the front cross support 610. The attachment bracket 600 has at least one front support slider 620, a second support slider 620 at the end of adjustable depth center support rear 614, and this same front support slider 620 is duplicated on the rear image side of the attachment bracket 600. These relationships could also be changed, or an entirely other means of allowing width and depth adjustment of the combination of the front and rear cross supports could be implemented. For instance, the front or rear cross support 610 or 612 may have a slot in it and the front support slider 620 may include a tab that cooperates with the slot thus allowing lateral movement of one component within the other.

To adjust the vertical height of the attachment bracket 600 so that it clears obstructions on the mower chassis or the mower deck, a pair of front height adjustment rods 604 are used. The rods 604 are threaded and cooperate with a welded height adjustment nut 606 that is attached to a slidable support bracket 630 and a rear bar member 632 (not shown). The bracket 630 is a tubular member with an inside diameter equal to the outside diameter of either the front cross support number 610 or the rear cross support 612. There are a total of 4 slidable support brackets 630 in this embodiment of the attachment system. On the front of the attachment bracket 600, support brackets 630 allow the spacing of a flotation foot assembly 12 to be increased or decreased depending on the caster yoke spacing on the front of the mower and in the rear of the mower the support brackets 630 allow lateral adjustment of a rear support foot member 634. The lateral adjustment of the rear support foot 634 is important as it allows the spacing of the rear support foot 634 to be adjusted based on the configuration of the mower chassis. This allows the rear support foot 634 to be put in a location for ideal support such as engaging a structural part of the chassis or to clear obstructions. By rotating the front height adjustment rod 604 up or down, the height of the entire attachment system is capable of being positioned so that it is above all obstructions extending from the mower chassis or mower deck and thus providing a generally planar surface for securement of the attachment bracket 600.

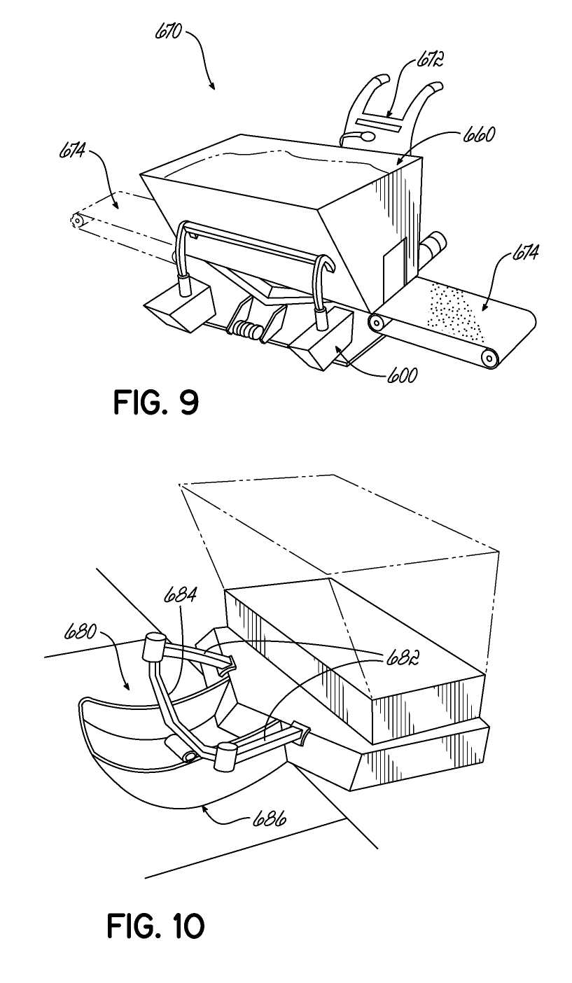

The rear support foot 634 is configured so that it can engage a tubular channel on the mower chassis or otherwise support the attachment bracket 600 by having a flared foot 636 resting against a portion of the mower deck or flat surface on the mower chassis. In one embodiment, the rear support foot 634 includes a rubber lining for its surfaces that come in contact with the mower chassis or mower deck. This helps reduce damage to the painted surface of either component. The attachment bracket 600 may also include a hopper attachment bracket 640. The bracket 640 consists of an up struck portion with an aperture therein. The aperture is configured to be aligned with a track assembly of a hopper 660 (as shown in FIGS. 9 and 10) is placed on the attachment bracket 600. Once aligned a bolt may pass through the aperture within the hopper attachment bracket 640. A commonly available bolt that may be integrated into a handle so that the bolt may be tightened without the need for a wrench. Of course, other attachment structure than a bolt may be used for attachment of the hopper 660 to the attachment bracket 600.

FIG. 9 shows the bulk material unloading system 670 having the hopper 660 connected with a mower device 672 using the optional attachment bracket 600. Absent use of the attachment bracket 600, the unloading system 670 could be transported through its own self propelled power means. The unloading system 670 is like unloading systems 200, 300, 400, and 500, but includes two optional output directions, with a conveyor assembly 674 capable of moving bulk material in either or both directions with respect to the hopper 660.

FIG. 10 shows an alternative embodiment of a flotation assembly 680 that can be used instead of the flotation foot assemblies 602. In this configuration yoke tubes 682 are connected by a lateral member 684 to a pivoting center flotation plate 686 consisting of a low friction material such as UHMW material that allows the flotation plate 686 to easily move over surfaces.

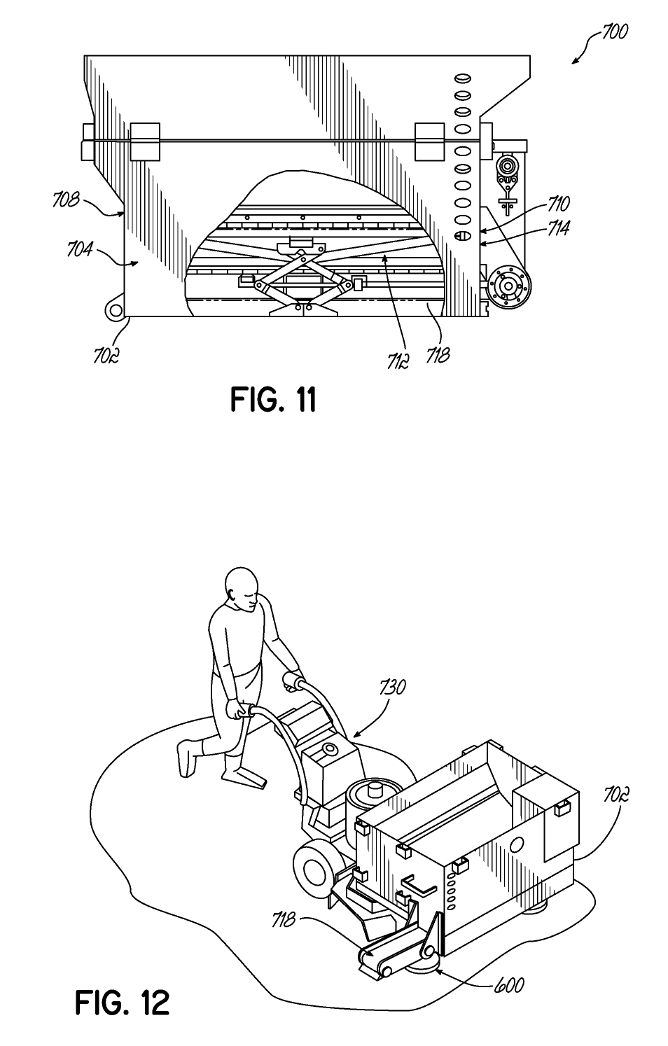

FIG. 11 shows a bulk material unloading system 700 in accordance with one embodiment of the invention. The bulk material unloading system 700 includes some common features of the other unloading systems 200, 300, 400, 500. The unloading system 700 includes a main housing 702 including side walls 704 and end walls 708, 710. A conveying device 712 is situated in the bottom of the housing 702 for conveying bulk material through an opening 714 in the end wall 710. The unloading system 700 includes a wing portion 716 (shown in FIG. 12) inside the housing 702 and that is configured to direct bulk material toward the conveying device 712. The wing portion 716 may be moveable with respect to the conveying device 712, similar to the moveable wings discussed above, or may be fixed. The conveying device 712 includes an endless loop conveyor belt 718 that extends outside of the main housing 702 to deliver bulk material. A connection bracket 720 is connected to the main housing 702 for connecting the unloading system 700 to another device.

FIGS. 12-15 show the unloading system 700 connected with a walk-behind mower 730. In particular, the unloading system 700 is connected with the mower 730 with the connection bracket 720 being pivotably connected with an attachment bracket 600 carried by and connected to the mower.

As shown in FIGS. 12-15, the main housing 702 is pivotably adjustable with respect to the attachment bracket 600. In a first, flat, position (shown in FIG. 12), the main housing 702 is in an orientation such that the conveyor belt 718 is generally parallel with the attachment bracket 600 and the mower deck. In a second, tilted, position, the conveyor belt 718 is tilted relative to the attachment bracket 600 and the mower deck. In the tilted position, bulk material is conveyed out of the main housing 702 at a higher position than in the flat position. The angle of the main body 702 with respect to the attachment bracket 600 may be adjusted by means of a hydraulic cylinder, a hydraulic bottle jack or a scissor jack placed (not shown) between the main body 702 and the attachment bracket 600, or the mower 730 itself.

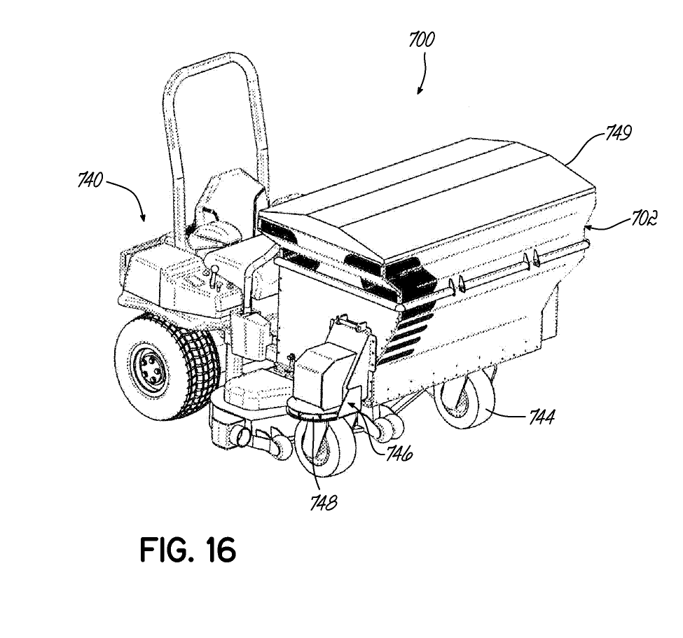

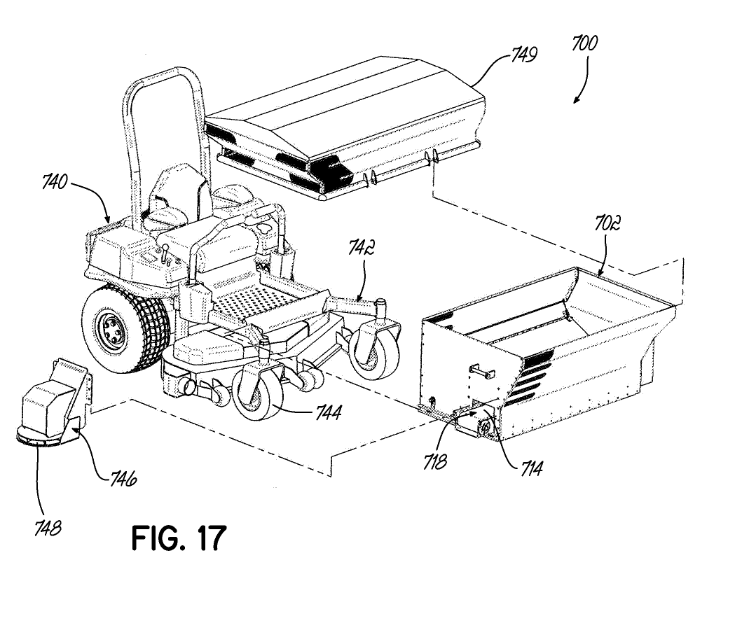

FIGS. 16 and 17 show the unloading system 700 connected with a ride-along style mower 740. The unloading system 700 is attached to the mower 740 by an attachment bracket 742 that is generally similar to the attachment bracket 600, but includes casters 744. As can be appreciated, unloading system 700 could be connected to any other type of suitably sized mower or connected to its own self propelled transport device. A broadcasting device 746 is attached to the main housing 702 and covers the opening 714. The broadcasting device 746 includes a broadcasting spinner 748 for distributing bulk material. In use, bulk material moved by the conveyor belt 718 exits the opening 714 and falls into the broadcasting device 746, where it is subsequently spread or broadcasted by the broadcasting spinner 748. The unloading system 700 includes a lid, 749.

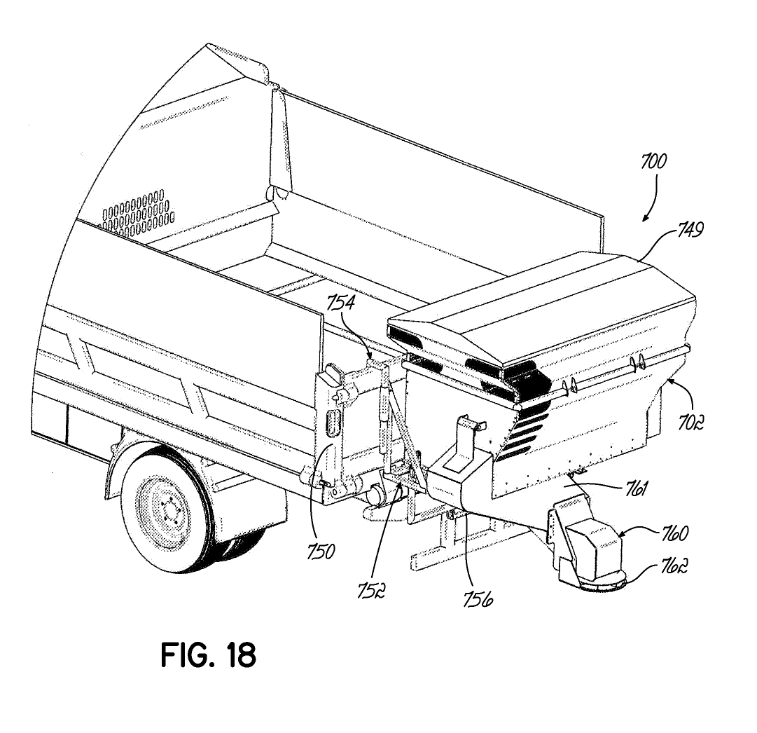

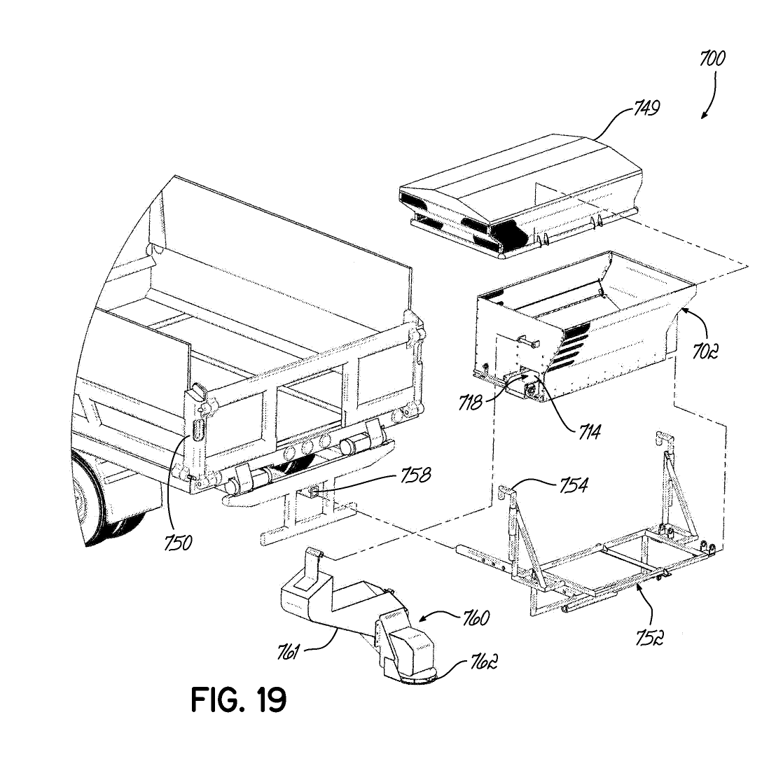

FIGS. 18 and 19 show the unloading system 700 connected with a tailgate 750 of a truck. Alternatively, unloading system 700 could be placed at least partially in the truck's bed rather than connected to its tailgate or by way of adapter bracket trailer hitch attached to the truck's chassis. The unloading system 700 is attached to the tailgate 750 by an attachment bracket 752, which is configured to support the unloading system 700, as shown. The attachment bracket 752 includes hooks 754 that hook over the tailgate 750, and may also include a hitch attachment 756 for mating with a hitch receiver 758 of the truck. A broadcasting device 760 is attached to the main housing 702 and covers the opening 714. The broadcasting device 760 includes an extension chute 761 and a broadcasting spinner 762 for distributing bulk material. In use, bulk material moved by the conveyor belt 718 exits the opening 714 and falls into the broadcasting device 746, falls through the extension chute 761, and is subsequently spread or broadcasted by the broadcasting spinner 762.

Thus, the unloading system 700 is readily adaptable for connection with several types of vehicles, and can be used for distributing several types of bulk material, as desired or appropriate.

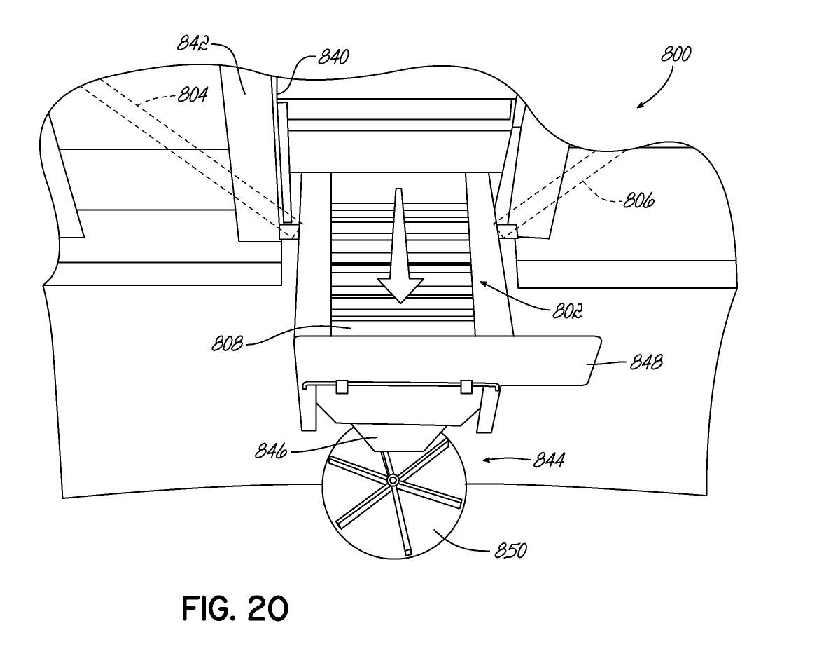

FIG. 20 shows a bulk material unloading system 800 in accordance with one embodiment of the invention, which shares many common features with the unloading systems 200, 300, 400, 500. The unloading system 800 includes a conveyor assembly 802 and wings 804, 806, which are moveable with respect to the conveyor assembly 802, like wings 204, 206, 404, 406, 504, and 506. The conveyor assembly 802 includes a conveying device 808 for moving bulk material. Whereas the conveying device in unloading systems 200, 300, 400 and 500 show a conveying device that stops proximate the end of the truck bed, the conveying device 808 is configured to extend through an opening 840 in a tailgate 842. The unloading system 800 further includes a broadcasting device 844, which includes a collection funnel 846 situated below a terminal end of the conveying device 808. Bulk material moving along the conveying device 808 falls into the collection funnel 846. A guard 848 is positioned beyond the terminal end of the conveying device 808 to direct any bulk material into the collection funnel 846. A broadcasting spinner 850 is positioned below the collection funnel 846, and bulk material falling into the collection funnel 846 is subsequently broadcast by the broadcasting spinner 850. In an alternative embodiment not shown, the collection funnel could cooperate with a chute so that a conveying device not extending through an opening in the tailgate of the truck could allow bulk material to be deposited into said chute which then routes the bulk material either to a broadcasting spinner or a gate jack allows funnel to pass bulk material down the chute prior to coming into contact with the broadcasting spinner 850.

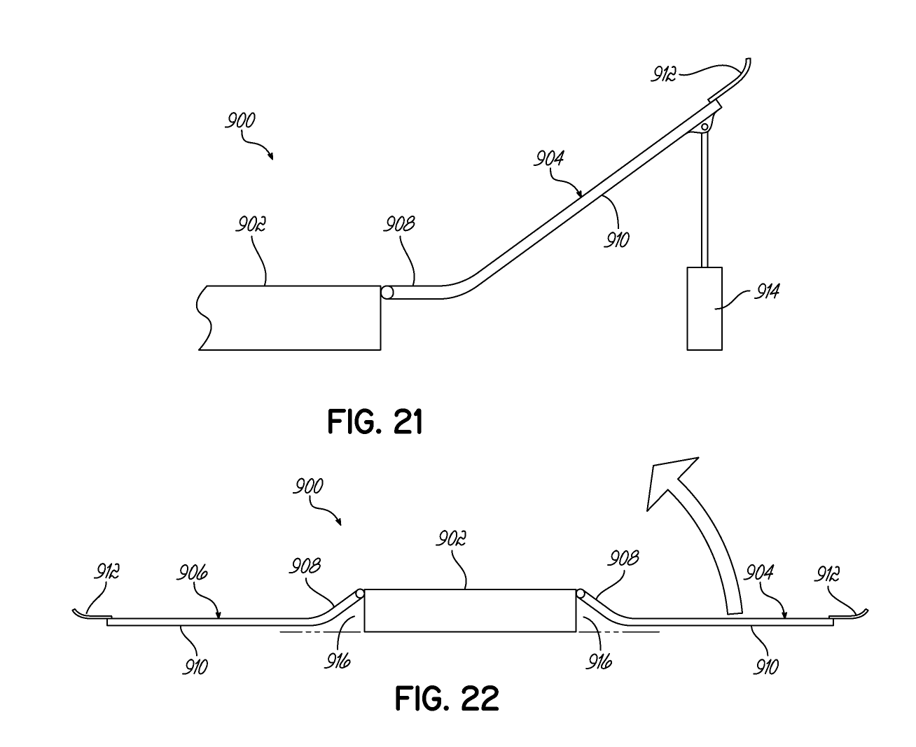

FIGS. 21 and 22 schematically depict wing profiles in accordance with one embodiment of the invention for a bulk material unloading system 900 that includes a conveyor assembly 902 and wings 904, 906. The wings 904, 906 are generally mirror images of each other, so features will be described with respect a single one of them. Wing 904 includes a first section 908 that is attached with the conveyor assembly 902 and a second section 910 extending from the first section 908. The two sections 908, 910 meet at a curved junction which is relatively near the conveyor assembly 902. The wings are moveable between at least two positions. In a first, flat, position shown in FIG. 22, the second sections 910 are generally parallel with a direction of movement of the conveyor assembly 902. In a second, raised position, shown in FIG. 21, the second section 910 is raised and the first section 908 is generally parallel with a direction of movement of the conveyor assembly 902. The wings 904, 906 optionally include wing flaps 912, and can be associated with a lifting device 914, but it will be appreciated that the wing profiles of the wings 904, 906 have application in other particular embodiments, as well.

The wing profile of the wings 904, 906 generally increases the amount of bulk material that can be supported above the wings 904, 906, as compared with wings that are completely planar, as completely planar wings would extend from the conveyor assembly 902 in a way that fails to use the volume space under the wings 904, 906. In the embodiment shown, the wings 904, 906 create only a small volume 916 of space that is unusable.

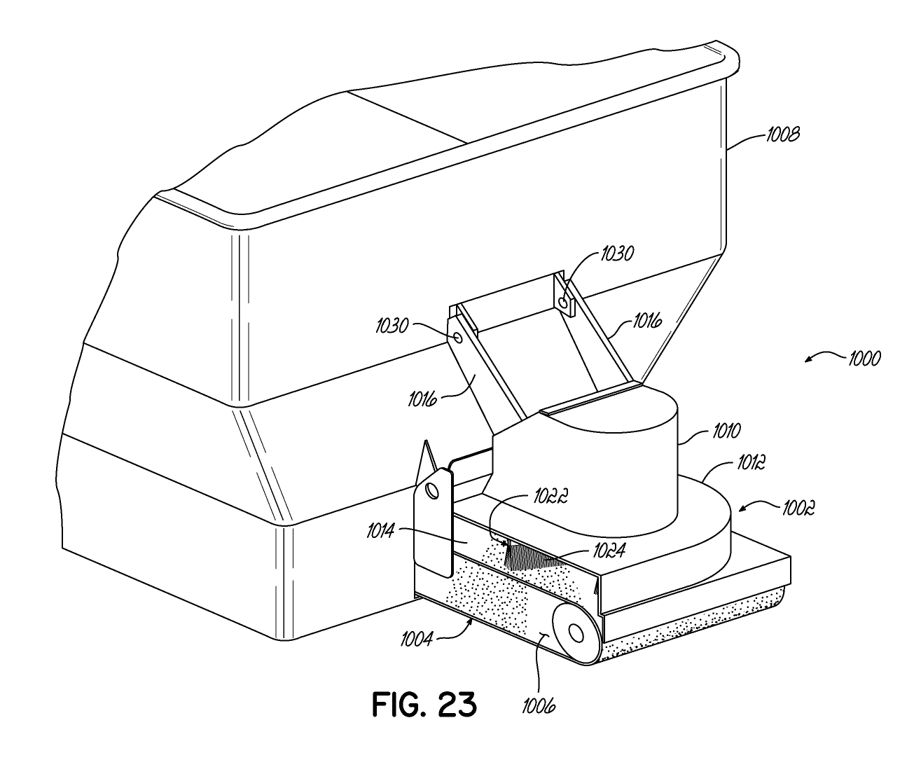

FIGS. 23-26 show a bulk material unloading system 1000 in accordance with one embodiment of the invention and having a bulk material dispersion device 1002 is shown. The dispersion device 1002 is configured to be used in conjunction with many types of unloading systems, such as those disclosed above. The unloading system 1000 includes a conveyor assembly 1004, which in the embodiment shown includes an endless loop conveyor belt 1006. The dispersion device 1002 is configured to selectively contact and disperse bulk material that is moved out of a hopper 1008 of the unloading system 1000.

The bulk material dispersion device 1002 includes a main housing 1010 that includes a positionable directional guard 1012 and a discharge opening 1014. In some instances, it may be desirable to remove directional guard 1012 all together. The directional guard 1012 and the discharge opening 1014 generally influence the direction that the bulk material is dispersed from the conveyor belt 1006. The main housing 1010 is attached to the hopper 1008 by attachment arms 1016. Other attachment means can be used such as hydraulic.

The bulk material dispersion device 1002 also includes a bulk material engagement assembly 1020 for contacting and moving the bulk material. In the embodiment show, the bulk material engagement assembly 1020 includes a motor-driven brush assembly 1022. The brush assembly 1022 includes a plurality of strip style brushes 1024 that are connected with and extend radially from a hub 1026. The hub 1026 is rotationally driven by a motor 1028. The motor 1028 is contained with the main housing 1010, as shown. Of course, other types of brushes could also be used such as circular brushes, or the brush assembly 1022 could be replaced with a rigid or semi rigid wiping member or a combination of rigid or semi rigid wiping members and a brush. The power means for the brush assembly could take any of the forms described in association with unloading systems 200, 300, 400 and 500. In some embodiments the brush assembly 1022 is powered by a hydraulic motor.

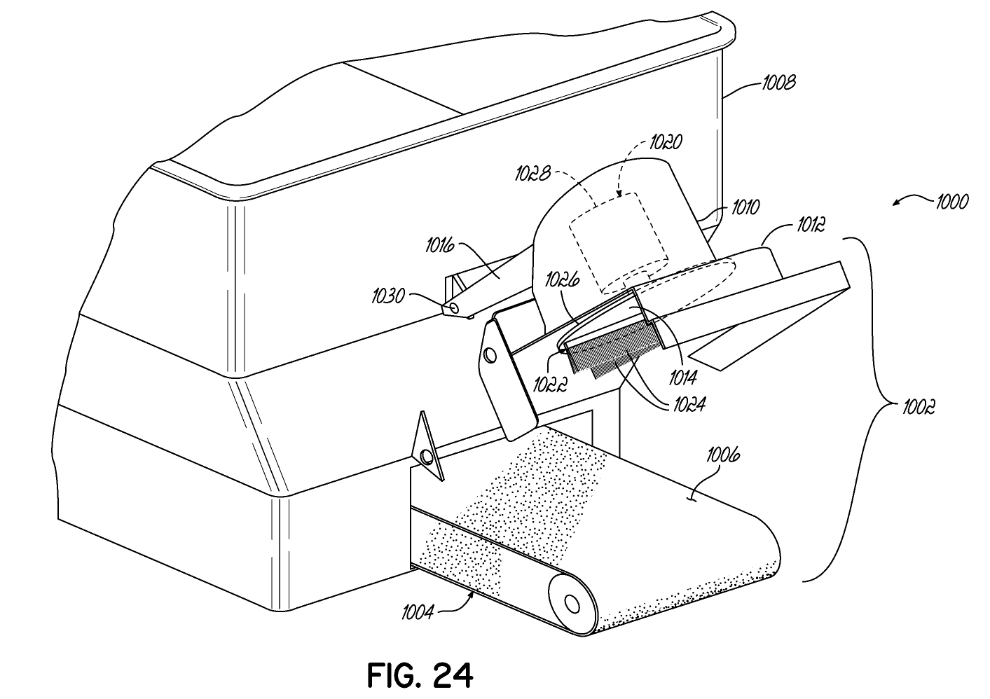

The dispersion device 1002 is selectively moveable between at least two positions with respect to the conveyor belt 1006. In a first position (as shown in FIG. 23), the bulk material engagement assembly 1020 is positioned relative to the conveyor belt 1006 so the brush assembly 1022 can be in contacting relationship with the bulk material moving on the conveyor belt 1006. In a second position (as shown in FIG. 24), the bulk material engagement assembly 1020 is positioned relative to the conveyor belt 1006 so the brush assembly 1022 will not be in contacting relationship with the bulk material moving on the conveyor belt 1006. For example, in the embodiment shown, the attachment arms 1016 that connect the main housing 1010 with the hopper 1008 are connected at a pivoting joint 1030. The main housing 1010 is therefore generally pivotable with respect to the hopper 1008 about the pivoting joint 1030, providing for the dispersion device 1002 to be moved between the first and second positions described. In other embodiments, the conveyor belt 1006 may be moveable relative to the dispersion device 1002 in a manner that provides movement between the first and second positions. Relative movement between the dispersion device 1002 and the conveyor belt 1006 can be by any appropriate means, and can be manually or automatically controlled.

The motor 1028 is configured to rotate the hub 1026, and thereby the brushes 1024, in either rotational direction. It may be desirable to configure dispersion device 1002 so that rotation of the brush assembly 1022 begins prior to actuation of the conveyor belt 1006. When the bulk material engagement assembly 1020 is in its first position, the brushes 1024 are caused to rotate into engagement with the bulk material moving on the conveyor belt 1006. The brushes 1024 thereby engage and move the bulk material with respect to the conveyor belt 1006 and cause the bulk material to be dispersed in a manner different from bulk material that is simply moved off the end of the conveyor belt 1006. For example, the bulk material engagement assembly 1020 can cause the bulk material to be generally dispersed away from the dispersion device 1002, and across a wide angle of dispersion. Moreover, the shape of the directional guard 1012 and the position of the discharge opening 1014 can be selected to provide a desired pattern of dispersal of the bulk material. In the event that the device is converted for the distribution of granulated material such as fertilizer, snow and ice control materials, or seed, a broadcasting spreader type device may be attached.

The motor 1028 can be powered by any appropriate power source, and can be actuated in any appropriate manner. For example, the motor 1028 can be powered, either perpetually or selectively, when the bulk material engagement assembly 1020 is in its first position. Power to the motor 1028 can be terminated, however, when the bulk material engagement assembly 1020 is in its second position.

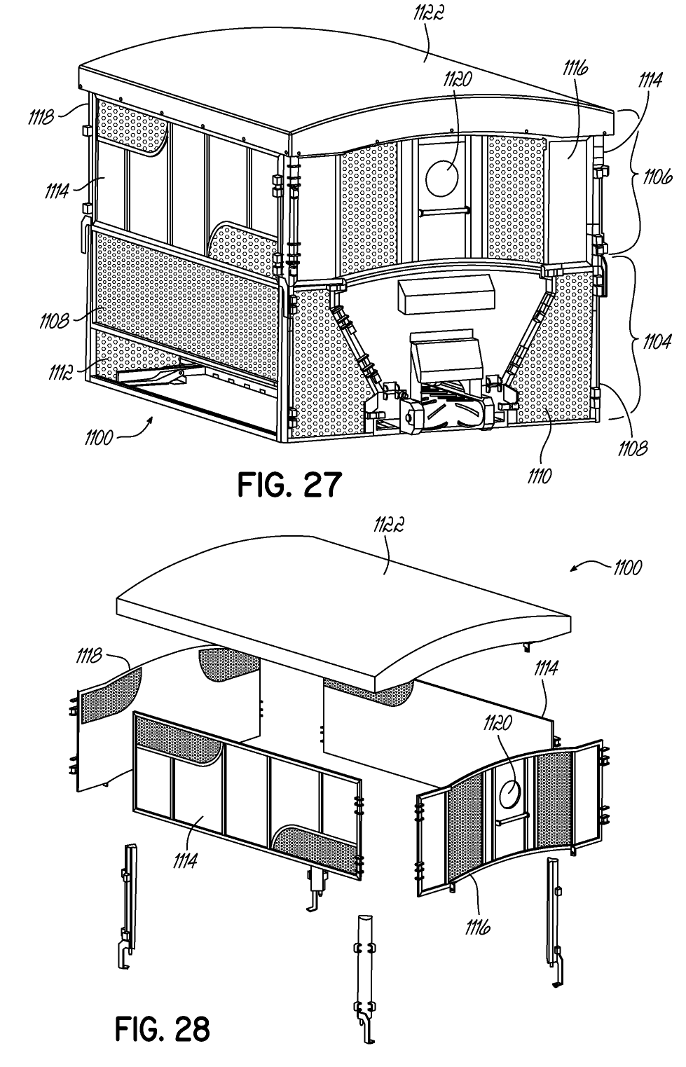

FIGS. 27 and 28 show a bulk material unloading system 1100 in accordance with one embodiment of the invention and a bulk material retention assembly 1102. The unloading system 1100 can be similar to any of the previously discussed unloading systems, such as unloading systems 200, 300, 400, 500, 700, 800, 900, and 1000.

The bulk material retention assembly 1102 is configured to provide an enclosure structure essentially surrounding the unloading system 1100, and includes a lower section 1104 and an upper section 1106. The lower section 1104 generally extends to an upper region of the unloading system 1100, and the upper section 1106 is positioned above the lower section 1104.

The lower section 1104 includes side panels 1108, and front and rear end panels 1110, 1112. The side panels 1108 and end panels 1110, 1112 are connected with one another, and the end panels 1110, 1112 are connected with the unloading system 1100, as shown.

The upper section includes side panels 1114, front and rear end panels 1116, 1118. The side panels 1114 and end panels 1116, 1118 are connected with one another, as shown. In addition, the panels 1114, 1116, 1118 of the upper section 1106 are connected with the panels 1108, 1110, 1112 of the lower section 1104, as shown. The front panel 1116 can optionally include an opening 1120 for receiving materials drawn in by a vacuum-type debris loader (not shown).

The combined lower section 1104 and upper section 1106 define an internal space that can hold bulk materials, such as leaf debris, which may be placed into the internal space through the opening 1120.

In addition, a cover member 1122 is provided for covering the upper section 1106, as shown.

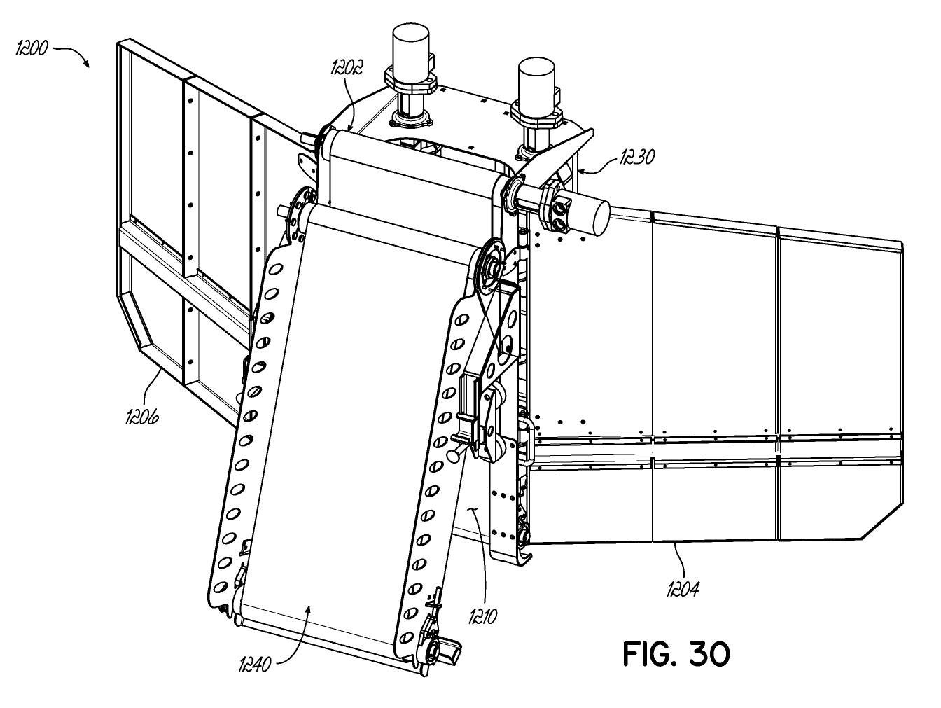

FIGS. 29 and 30 show a bulk material unloading system 1200 in accordance with one embodiment of the invention, which is generally similar to the preceding unloading systems, but is configured to be operated with a generally non-horizontal orientation. The unloading system 1200 generally includes a conveyor assembly 1202 between two moveable wings 1204, 1206. The conveyor assembly 1202 includes a conveying device 1208, which in the embodiment shown includes a planar endless conveyor belt 1210. The conveyor assembly 1202 also optionally includes a modular conditioner assembly 1230 for agitating bulk material as it is moved along the conveyor belt 1210. The conditioner assembly 1230 includes a pair of agitating bars 1232 each having a plurality of agitating protrusions 1234. The agitating bars 1232 and agitating protrusions 1234 can serve to convey bulk material, in addition to agitating it. The wings 1204, 1206 can be associated with a lifting device, such as the hydraulic lift mechanism and scissor jack assemblies discussed above.

The unloading system 1200 also generally includes an optional secondary conveyor assembly 1240, which is adjustable connected with respect to the conveyor assembly 1202. The secondary conveyor assembly 1240 is configured to receive bulk material from the conveyor assembly 1202 and provide additional movement of the bulk material.

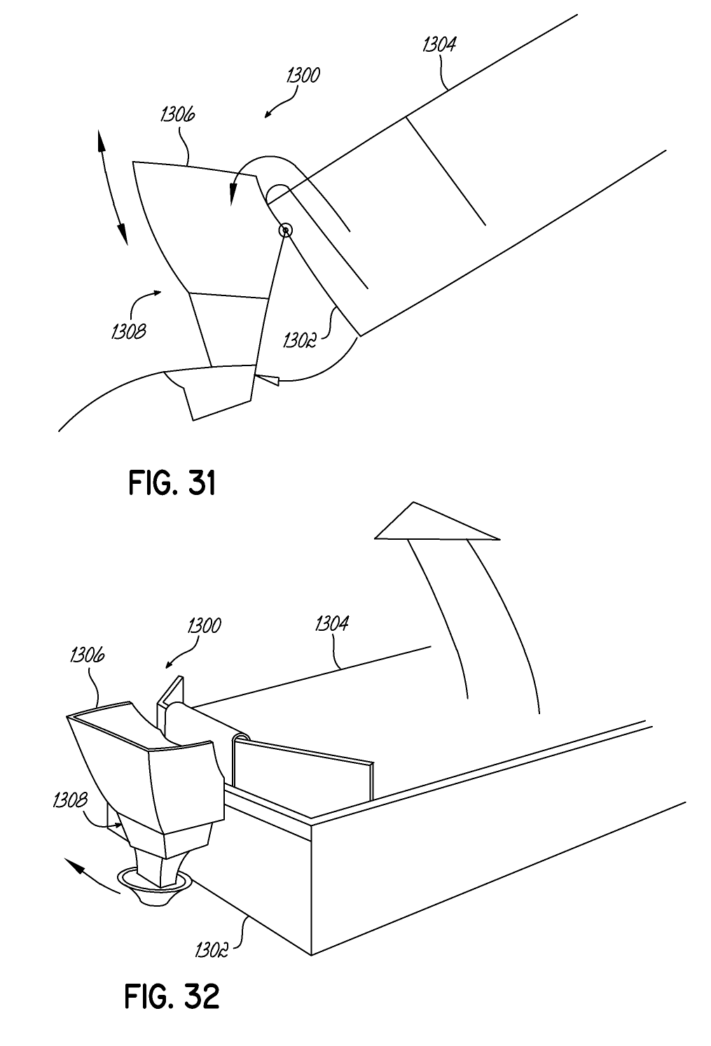

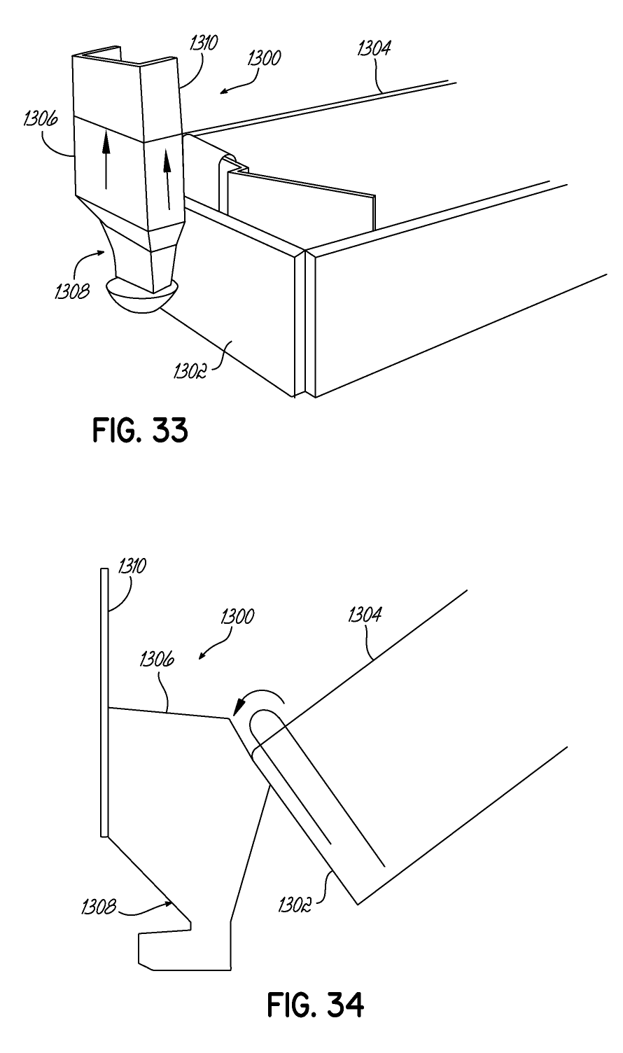

FIGS. 31-34 show a bulk material unloading system 1300 in accordance with one embodiment of the invention, which is generally similar with the unloading system 1200. Unloading system 1300 is configured to be situated near the tailgate 1302 of a truck and to remove bulk material from the bed 1304 of the truck. For example, as shown in FIGS. 31-32, the unloading system 1300 is configured to move bulk material into the hopper 1306 of a broad-cast type spreader system 1308 pivotally attached to the tailgate 1302 so that when the tailgate 1302 is raised, the bulk material admittance opening of spreader system 1308 remains generally level. In FIGS. 33-34, the spreader system 1308 includes a backstop 1310 moveable with respect to the hopper 1306, and configured to guide bulk material into the hopper 1306.

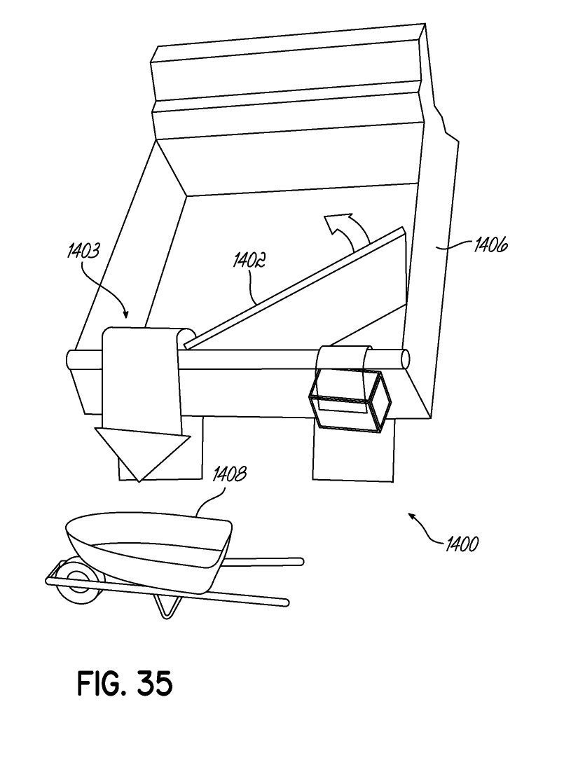

FIG. 35 shows a bulk material unloading system 1400 in accordance with one embodiment of the invention, which is generally similar with the unloading systems 1200, 1300, but only includes a single wing 1402. The conveyor assembly 1403 is therefore positioned near a sidewall 1404 of the truck bed 1406, as shown. The unloading system 1400 can be used to move bulk material from the truck bed 1406 into a container, such as a wheelbarrow 1408.

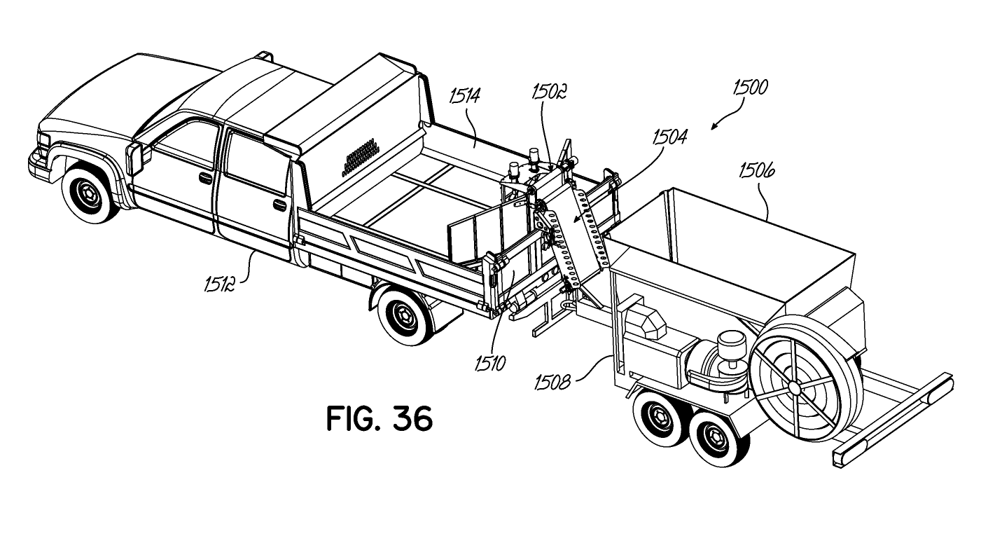

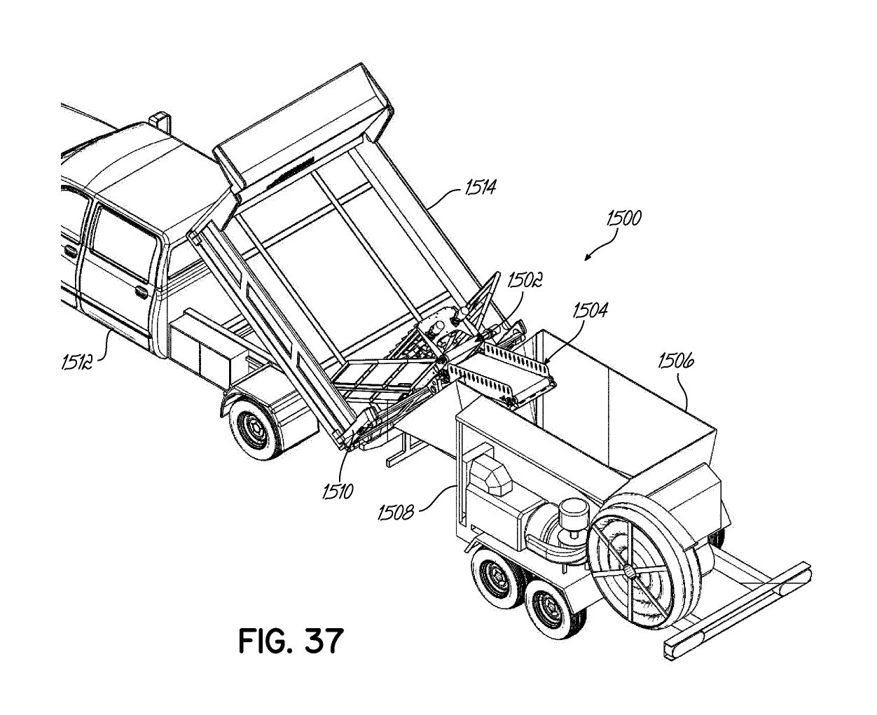

FIGS. 36-38 show a bulk material unloading system 1500 in accordance with one embodiment of the invention, which is generally similar with the unloading systems 1200, 1300, 1400 and includes a first conveyor assembly 1502 and a second conveyor assembly 1504. In a first, transport position (shown in FIG. 36), the second conveyor assembly 1504 is lowered. In a second, operational position (shown in FIG. 37), the second conveyor assembly 1504 is raised so as to receive bulk material moved by the first conveyor assembly 1502. The second conveyor assembly 1504 may be pivotally moved between the first and second positions. In particular, the second conveyor assembly 1504 moves bulk material to a hopper 1506 of an auxiliary distribution device 1508. In particular, the secondary conveyor assembly 1504 carries the bulk material across the span generally between the tailgate 1510 of the truck 1512 and the hopper 1506. This reduces the amount of bulk material that falls to the ground as it transferred from the bed 1514 of the truck 1512 to the hopper 1506.

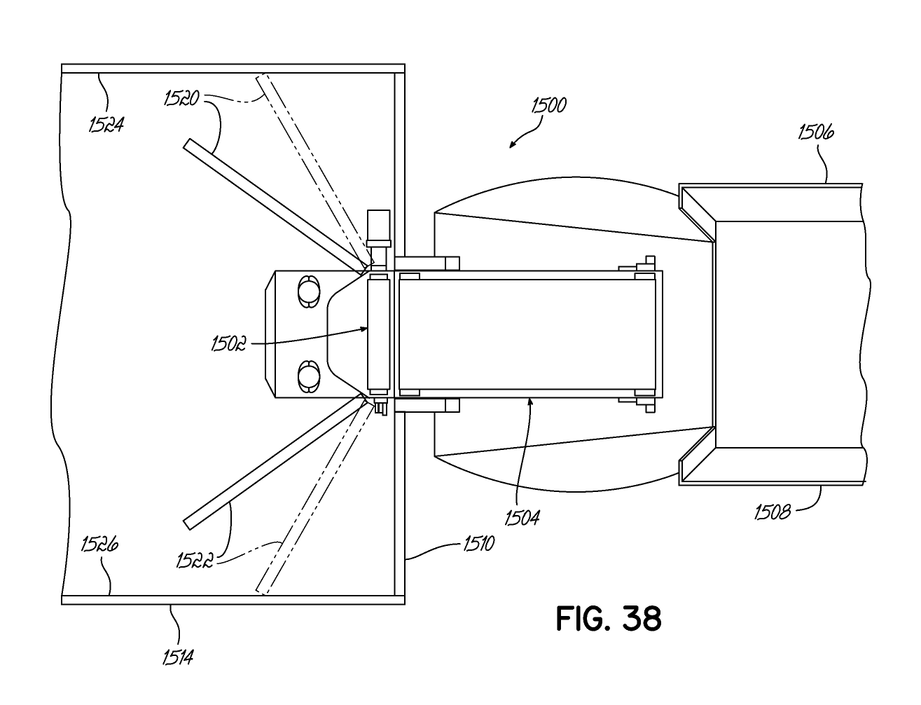

FIG. 38 depicts the wings 1520, 1522 of the unloading system 1500, and shows that they are moveable with respect to the first conveyor assembly 1502. In particular, the wings 1520, 1522 are moveable with respect to the sidewalls 1524, 1526 of the bed 1514.

FIGS. 39A-39C show a bulk material unloading system 1600 in accordance with one embodiment of the invention that is configured to unload bulk material from the bed 1602 of a truck 1604. Particularly, the unloading system 1600 is a transverse-type unloading system that moves bulk material contents to the side of a truck for deposit into a container, such as a wheelbarrow 1606, as shown. The unloading system 1600 includes a conveyor assembly 1608, and is generally connected with the truck's tailgate 1610, attached by hooks 1612. When the tailgate 1610 is in the closed position (as shown in FIG. 39C), the conveyor assembly 1608 is generally parallel with the tailgate 1610. The tailgate 1610 is supported by chains 1614, and the chains 1614 are configured to provide the tailgate 1610 in a position relatively parallel with the ground when the tail bed 1602 is raised (as shown in FIG. 39B). The unloading system 1600 may include a retention panel 1620 at one end of the conveyor assembly 1608 for blocking the flow of bulk material. The retention panel 1620 may be moved between the two ends of the conveyor assembly 1608, as desired.

As the truck bed 1602 is raised, the bulk material therein slides downwardly and reaches the conveyor assembly 1608. The conveyor assembly 1608 then moves the bulk material which moves material transversely relative to the orientation of a truck 101. The unloading system 1600 may also include a conditioner assembly, as discussed above.

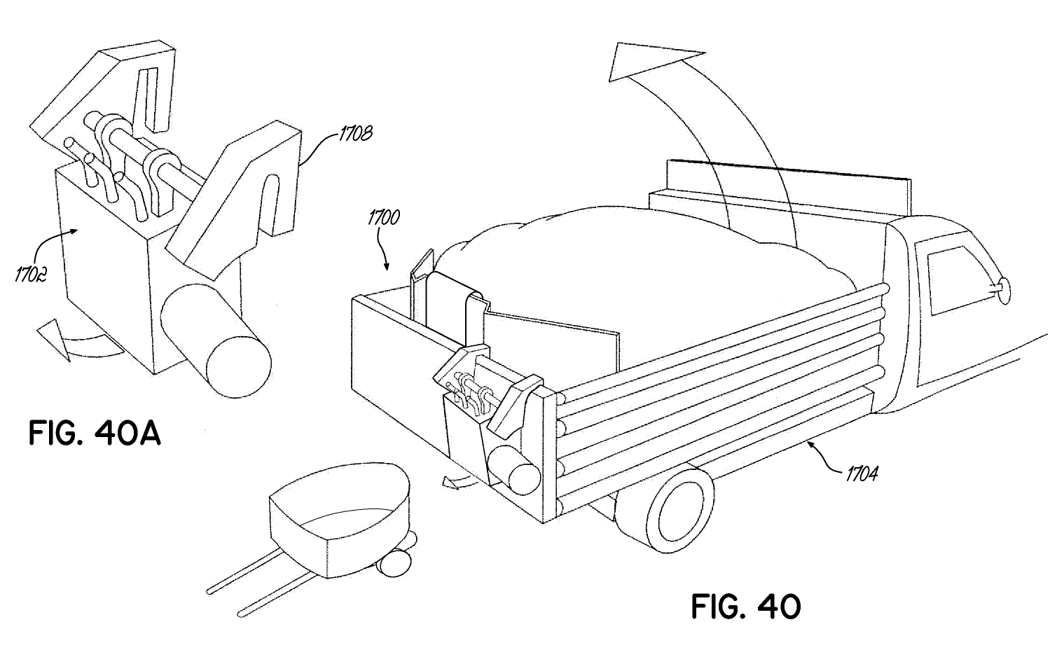

FIGS. 40 and 40a show a bulk material unloading system 1700 in accordance with one embodiment of the invention, which is generally similar to the unloading systems 1200, 1300, 1400, 1500. The unloading system 1700 is powered by a power pack 1702. The power pack 1702 is removably attachable with the truck 1704, such as on the tailgate 1706 by hooks 1708. The power pack 1702 is configured for powering the unloading system and to that end can include incorporates hydraulic components and an engine for generating the appropriate power for the unloading system 1700.

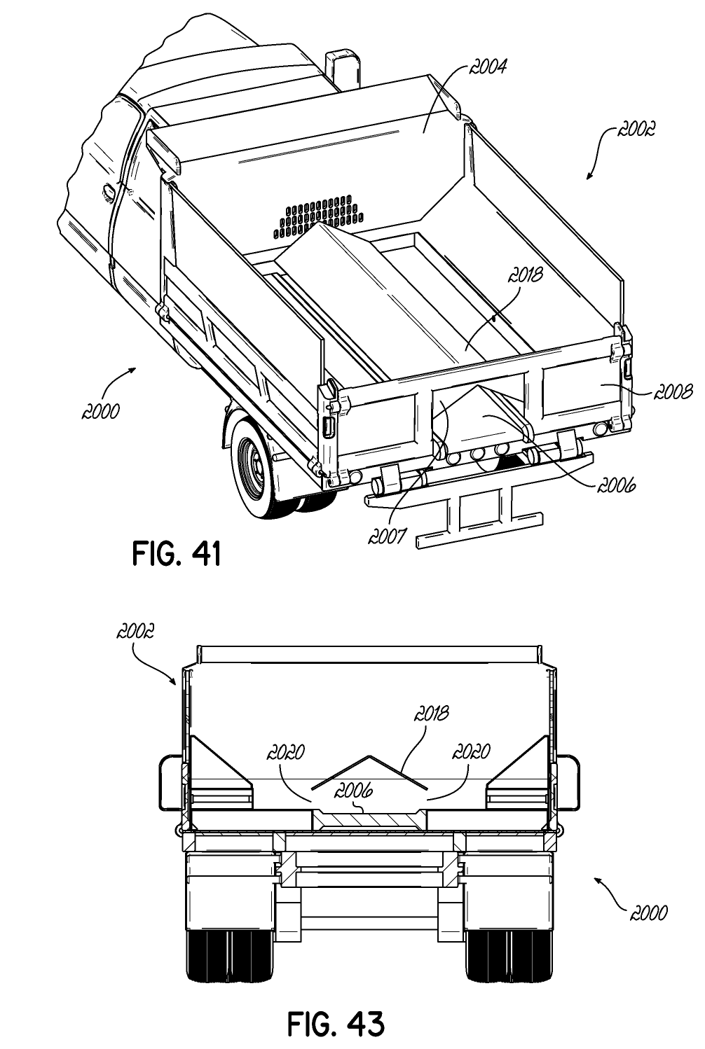

FIG. 41 illustrates another embodiment of the present invention implementing a combination of push elements directing bulk material to a conveyor to be discharged, such as from the back of a vehicle. Turning to FIG. 41, a typical dump truck vehicle 2000 is illustrated, having the discharge system 2002 supported therein. The discharge system 2002 sits in the bed 2004 of the vehicle 2000. A conveyor 2006 directs material from bed 2004 out of a discharge opening 2007, such as in the rear of the bed. An appropriate opening in the tailgate 2008 of vehicle 2000 may be used to form the discharge opening 2007. FIG. 41 illustrates an exploded view of system 2002 that may be implemented in the bed of vehicle 2000. Specifically, conveyor 2006 may be placed in the bed, such as between raised floor elements 2010 on either side of the conveyor. Movable push blocks 2012 are configured to slide on top of the floor elements 2010, and thus, direct bulk material onto conveyor 2006 to be discharged. To that end, the push blocks are operably coupled with push cylinders 2014, which may be operated, such as hydraulically as appropriate to drive the push blocks and thus, push material into the center of bed 2004 and onto conveyor 2006.

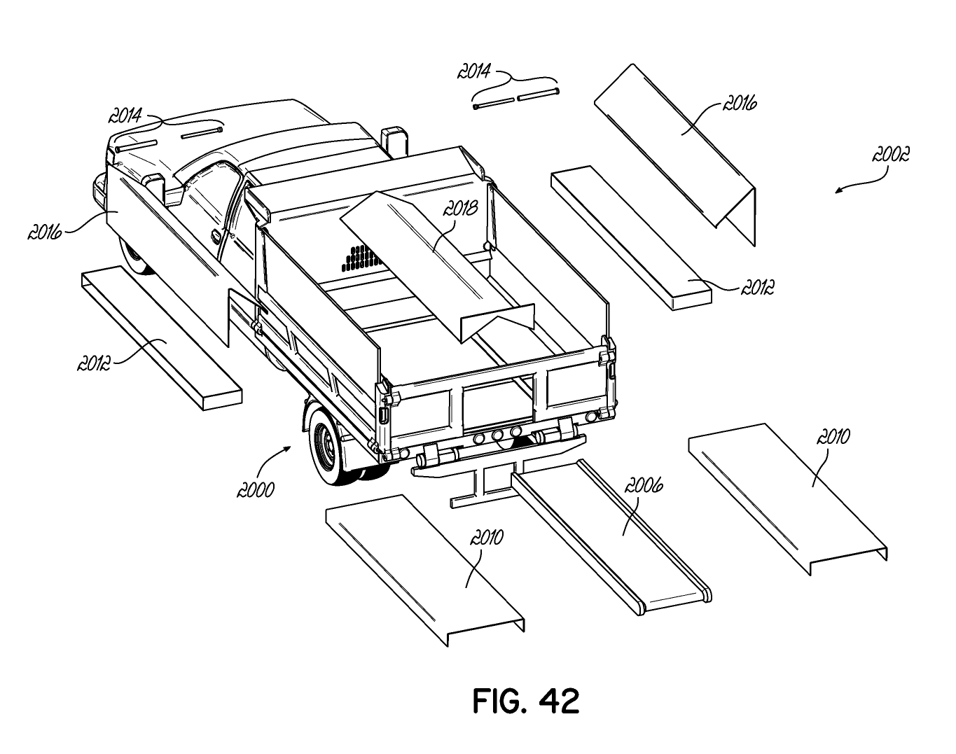

Angled panels 2016 are arranged on either side of the bed 2004, and overlie the movable push blocks 2012 for directing bulk material down onto the raised floor elements 2010, and onto the conveyor. A deflector element 2018 may be positioned in the bed 2004 between the angled panels 2016 to further direct bulk material onto floor elements 2010, and ultimately onto the conveyor 2006. The various elements are elongated, as shown and arranged in the long axis of bed 2004. The conveyor 2006 is operated in a conventional fashion, and may be driven so that it discharges from the bed in the direction of the arrow, as shown in FIG. 42.

FIG. 43 is an end view, and partial cross-section, of a truck implementing system 2002. Bulk material is delivered to bed 2004, and falls against the angled panels 2016, against the deflector element 2018, and onto the floor elements 2010. As may be appreciated, due to the weight of the bulk material and the shifting of a load, some of that bulk material will initially also fall onto conveyor 2006. Due to gravity, as conveyor 2006 is operated and discharges the bulk material from the opening 2007, additional bulk material falls down through the action of the angled panels 2016, and deflector element 2018 to fall onto floor elements 2010. Depending upon the load of bulk material, the natural force of gravity against the angled panels and the deflector element may be sufficient to direct that bulk material onto the conveyor 2006. Generally, the deflector element 2018 will be mounted at a position above conveyor 2006 so that bulk material will flow under deflector element 2018 in the direction of the arrows 2020 illustrated in FIG. 43.

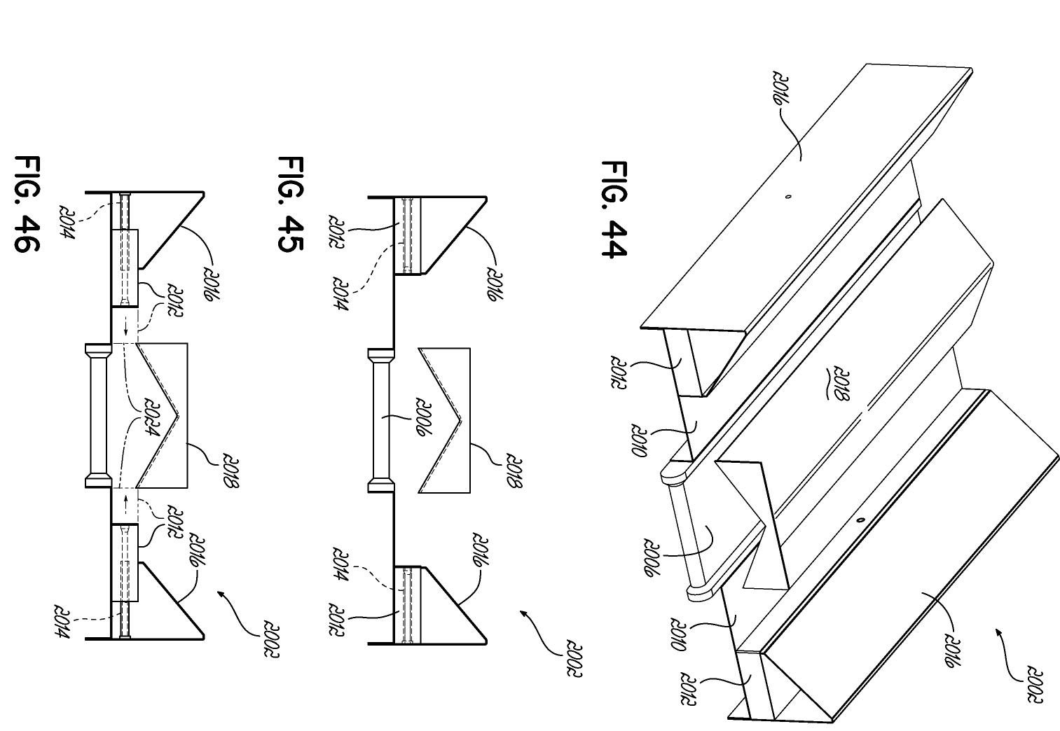

FIG. 44 illustrates another schematic view of system 2002 illustrating the suspension of the deflector element 2008 at a position above conveyor 2006 so that bulk material may slide onto the conveyor. Of course, it will be appreciated that the type of bulk material will dictate how well it flows over the angled panels 2016 and deflector element 2018, and onto conveyor 2016.

In accordance with another aspect of the invention, system 2002 also implements the movable push blocks 2012 under the actuation of cylinders 2014 to push bulk material from floor elements 2010 and onto conveyor 2006. FIG. 45 illustrates a side view, and partial cross-section, of elements of system 2002. Movable push blocks 2012 are illustrated in their fully-retracted positioned. In one embodiment of the invention, as illustrated in FIG. 45, the push blocks 2012 may be dimensioned with respect to the angled panels 2016 such that they lie underneath the angled panels when fully retracted.

Turning now to FIG. 46, the push blocks 2012 are illustrated in a partially extended position 2022, and then ultimately, a fully-extended position 2024. Generally, in the fully-extended position 2024, the push blocks will be up against a side edge of conveyor 2006 so that the bulk material may be moved or pushed completely from the floor elements 2002 onto the conveyor. To that end, generally the length of the block elements 2012 will match or be close to the length of conveyor 2006 so that as much of the bulk material as possible may be pushed off of the floor element and moved onto conveyor 2006 for being discharged.

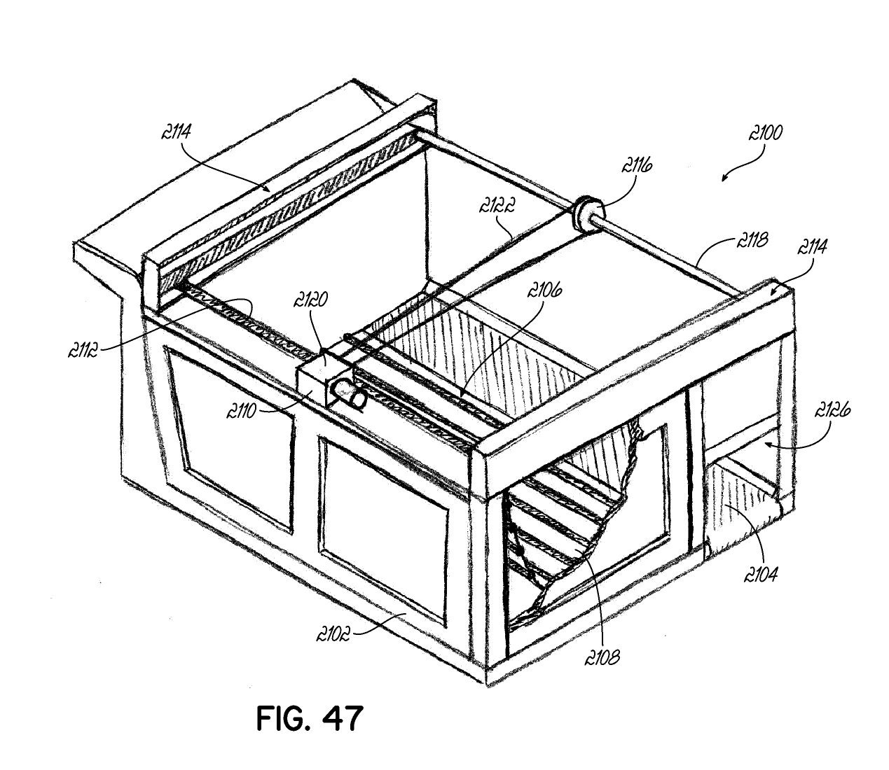

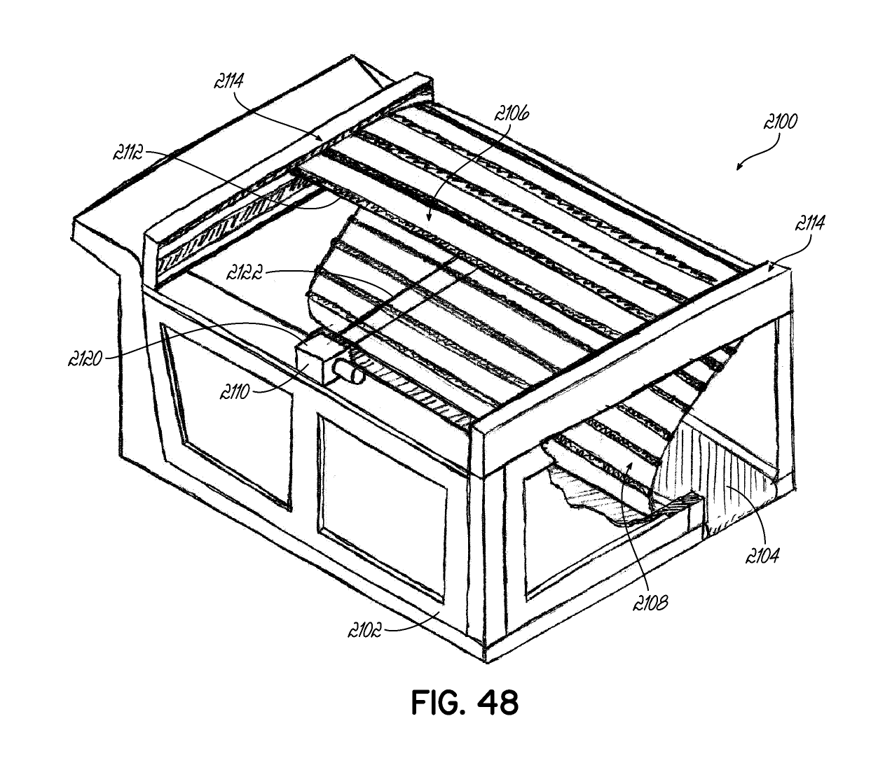

Another embodiment of the bulk material device 2100 is illustrated in FIGS. 47 and 48. The bulk material device is configured to be selectively attached to a vehicle and configured to allow for the distribution of bulk materials. The bulk material device 2100 is comprised of truck bed 2102, a means of conveyance or conveyor 2104. The conveyor 2104, for example, may be a flatbed conveyor outfitted with a smoother cleated rubber belt, a screw type auger conveyor, vibratory conveyor or other suitable component. A flexible positioner assembly 2106 for moving the bulk material on to the conveyor 2104. Flexible positioner assembly 2106 is comprised of a panel 2108, which is flexible in at least one axis. Panel 2108 could be made of material such as such as a thin sheet of polyethylene, a reinforced vinyl or canvas tarp, wire cloth or segmented slats of metal capable of rolling. Subassembly 2106 is further comprised of winch assembly 2110, although components such as winch assembly 2110 are commonly known in the art, it is to be understood that winch assembly 2110 includes a motor which could be electric or hydraulic or internal combustion, when desired, a gear reducer, a take-up reel, a cable 2122. The cable has attachment points with cross member 2112. In the case of hydraulic actuation, the winch assembly may be simplified through use of a high torque low-speed hydraulic motor. As others with ordinary skill the art will appreciate, winch assemblies with all the appurtenant internal components (not described herein) can be readily purchased as a self-contained packaged unit.

The subassembly 2106 further includes guide tracks 2114 paralleling the truck bed and conveyor beds marginal axis and mounted at a height above conveyor 2104 such that the mounting height will not interfere with bulk material being transferred on the conveyor. Yet further, subassembly 2106 includes a pulley 2116 and is capable of rotating about axel 2118. In an alternative variation, pulley 2116 could be attached to axel 2118 so that that the two components are rotated together, in which case bearing assemblies at the end of axel 2118 would need to be integrated into guide track 2114, thus allowing axel 2118 to rotate. The winch 2110 is further comprised of a power unit 2120 and cable 2122. The panel 2108 is fixed at one end near the base of the conveyor 2104, the other end of the panel 2108 is attached to a cross member 2112, which in turn rides within the guide tracks 2114. The cable 2122 is connected to the cross member 2112 such that as the winch assembly 2110 is operated in the direction of retraction the cross member 2112, it travels along the length of the guide tracks 2114. As shown in FIG. 47, the cable 2122 extends from the power unit 2120, over the pulley 2116, and is connected to the cross member 2112. The guide tracks 2114 are generally U-shaped and in the preferred embodiment, include an upper and lower section, although one skilled in the art could think of other possible track configurations that would work for the purpose of guiding the panel as it moves through its range of travel. FIG. 47 shows the bulk material device 2100 in its fully extended position, like it would be when the truck bed 2102 is filled. In contrast, FIG. 48 shows the positioner assembly 2106 in its fully-retracted position. Positioner 2106, in its fully-retracted position, represents the position it would be in when panel 2106 has deposited substantially all of the bulk material lying thereupon onto conveyor 2104.

In operation, bulk material device 2100 is placed in the bed of a truck bed 2102, positioner assembly 2106 is moved to its fully extended position such that bulk material such as snow and ice control materials, mulch or compost can be placed into it from the truck beds open topside, which also corresponds to the open topside of bulk material device 2100. Bulk material can be placed into the open topside through use of a loading device, such as a front end loader. Conveyor 2104 is actuated by device operator through the throwing of a switch or the like thereby moving bulk material down the conveyor 2104, and out of bulk material device 2100 generally at the end of truck bed 2102. The conveyor 2104 distributes the material out of the back of the truck bed 2102 through the outlet 2126. As the bulk material on the conveyor 2104 is depleted, positioner assembly 2106 is actuated and this results in the winch assembly 2110 drawing in cable 2122 which in turn moves cross member 2112 along track 2114 moving in the direction of the conveyor 2014. As the volume of material decreases from this distribution the amount of material available to the conveyor 2104 decreases until the point that no material resides on the conveyor. It is at this point that the positioner assembly 2106 is engaged to move the bulk material residing on the panel 2108 onto the conveyor. The cable 2122 is retracted, causing the panel 2108 to move and thereby shift its contents on to the conveyor 2104. When cross member 2112 reaches the end of track 2114's lower section, continued operation of winch assembly 2110 draws track 2114 upward into track 2114's upper section. Throughout this process, panel 2108 continues to deposit incremental volumes of bulk material onto conveyor 2104 until bulk material device 2100 is substantially emptied of bulk material.

Although various embodiments of the bulk material unloading systems disclosed herein incorporate dual wings, a single wing, or other number of wings could also be used, similar to the single-wing configuration shown in FIG. 35. Generally, the features of any of the embodiments disclosed herein may be combined with one or more features of any other embodiments.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive.

What is claimed is:

1. A system for unloading bulk materials from a truck, the system comprising:
a powered conveyor assembly configured for being positioned with respect to a truck to engage bulk material in the truck, the conveyor assembly operable for moving the bulk material;
one or more operable wings configured for being positioned to contact the bulk material in the truck and operable to move for directing the flow of a bulk material to the conveyor assembly.

2. The system of claim 1, wherein the conveyor assembly includes a movable conveyor belt, the movement of the conveyor belt being controlled automatically depending on the weight of the bulk material in the truck.

3. The system of claim 1, wherein the operable wings are proximate to the conveyor assembly but detached from the conveyor assembly.

4. The system of claim 1, wherein the operable wings are hingedly coupled with the conveyor assembly.

5. The system of claim 1 wherein an operable wing is movable between a flat first position generally parallel with the bed of a truck and an angled second position that is angled with respect to the truck bed.

6. The system of claim 5 wherein an operable wing can be locked in the angled second position.

7. The system of claim 1 wherein the powered conveyor assembly includes a movable conveyor belt for moving bulk material and a dispersion device, the dispersion device configured for engaging the conveyor belt to disperse bulk material moved by the conveyor belt.

8. The system of claim 7 wherein the dispersion device is movable relative to the conveyor belt, the dispersion device, in a first position, engaging the conveyor belt and, in a second position, disengaged from the conveyor belt.

9. A bulk material conveyance device for selective insertion onto the body of a truck configured for transporting bulk material, the device capable of unloading bulk material from the truck body and comprising:
a powered conveyor assembly;
at least one movable wing positioned proximate the conveyor assembly and movably mounted along the conveyor assembly;
the conveyor assembly being positioned on the truck body to convey bulk material to an end of the truck body for discharging the bulk material from the truck body;
the movable wing operable for moving bulk material lying thereon onto the conveyor assembly.

10. The device of claim 9 further comprising a panel for containing bulk material on the conveyor assembly, the panel including at least one opening generally aligned with a discharge end of the conveyor assembly.

11. The device of claim 10 whereby the panel is fixedly attached to the device and is substantially as wide as the conveyor assembly.

12. The device of claim 11 whereby the panel is fixedly attached to the device and is substantially as wide as the width of the conveyor assembly and at least one movable wing.

13. The device of claim 10 further comprising multiple panels for containing bulk material on the conveyor assembly, the multiple panels capable of moving independently of other panels.

14. The device of claim 13 whereby at least one of the multiple panels is fixedly attached to a movable wing.

15. The device of claim 13 wherein the multiple panels are positioned at both the front and rear ends of the conveyor assembly.

16. The device of claim 9 wherein a movable wing is hingedly coupled with the conveyor assembly.

17. The device of claim 16 wherein the movable wing is hingedly coupled with the conveyor assembly at generally the same elevation as the conveyor assembly, the movable wing operable for being elevated so bulk material can flow off the elevated wing onto the conveyor assembly.
